(19) United States
(12) Patent Application Publication
(10) Pub. No.: US 2026/0278459 A1
(43) Pub. Date: Sep. 17, 2026

(54) SCALABLE AGENTIC FRAMEWORK FOR ENTERPRISE ARTIFICIAL INTELLIGENCE

(71) Applicant: C3.ai, Inc., Redwood City, CA (US)

(72) Inventors: Sina K. Pakazad, San Francisco, CA (US); Romain Juban, San Francisco, CA (US); Nikhil Krishnan, Los Altos, CA (US); Ian Wu, London (GB); Yang Song, Singapore (SG)

(73) Assignee: C3.ai, Inc., Redwood City, CA (US)

(21) Appl. No.: 19/304,447

(22) Filed: Aug. 19, 2025

Related U.S. Application Data
(60) Provisional application No. 63/771,252, filed on Mar. 13, 2025.

(51) Int. Cl. G06N 20/00

(52) U.S. Cl. CPC G06N 20/00

(57) ABSTRACT

The disclosed system addresses these limitations by providing a system and method for automatically generating an agentic framework, including the agents within that framework. The framework organizes and governs the behavior of agents that independently or collaboratively interact with machine learning models, retrieve and process information, and execute tasks in an adaptive and context-aware manner. Agents generated with a specific role, enabling them to perform specialized functions such as task decomposition, response refinement, external tool integration, or decision-making. Agents are also associated with machine learning models appropriate for agent-related tasks. By using direct preference optimization using both agent output and critiques of agent output in connection with large language models and ground-truth systems for accuracy validation, the framework iteratively improves the function of lower-complexity machine learning models.

### TECHNICAL FIELD

The present disclosure relates broadly to agentic generative artificial intelligence (AI) models, including multimodal models. In particular, the present disclosure relates to autonomous scalable agent creation, optimization, fine-tuning, and management in an enterprise AI framework.

### BACKGROUND

Generative AI models, such as large language models (LLMs) and generative multimodal models, can generate text, images, code, and other forms of content based on learned statistical patterns. These models are typically trained on large datasets and rely on artificial neural networks to produce outputs that mimic the properties of the training data. While generative AI has demonstrated significant advancements, conventional approaches often lack the ability to autonomously manage complex tasks, adapt dynamically to user needs, or coordinate multiple sub-tasks efficiently.

To address these challenges, AI agent frameworks have emerged as a mechanism for orchestrating generative AI models in an interactive, goal-directed manner. AI agents can act as intermediaries between users and generative models, autonomously executing tasks, retrieving relevant contextual information, and refining model outputs based on iterative feedback. However, conventional AI agent implementations suffer from various inefficiencies, such as high computational overhead and limited adaptability.

### BRIEF DESCRIPTION OF THE DRAWINGS

The embodiments are illustrated by way of example and not by way of limitation in the figures of the accompanying drawings. In the drawings:

FIG. 1 illustrates a machine learning engine in accordance with one or more embodiments;

FIG. 2 illustrates the operation of a machine learning engine in in accordance with one or more embodiments;

FIG. 3 illustrates a system in accordance with one or more embodiments;

FIG. 4 illustrates an example set of operations for training dataset generation and distillation in accordance with one or more embodiments;

FIG. 5 illustrates an example set of operations for training dataset generation and distillation in accordance with one or more embodiments; and

FIG. 6 illustrates an example set of operations for training a machine learning model in accordance with one or more embodiments.

FIG. 7 illustrates an example agent fine-tuning process in accordance with one or more embodiments.

FIG. 8 shows a block diagram that illustrates a computer system in accordance with one or more embodiments.

### DETAILED DESCRIPTION

Generative artificial intelligence (AI) models, including transformer based multimodal generative models, have demonstrated significant advancements in content generation, task automation, and interactive decision-making. However, conventional generative AI approaches typically operate as static models, relying on single-turn interactions and predefined workflows, limiting their ability to dynamically adapt to complex, multi-step objectives. Agentic frameworks for generative models introduce an additional layer of intelligence by incorporating structured reasoning, iterative decision-making, and contextual memory mechanisms. These agentic frameworks enable generative AI systems to autonomously manage tasks, interact with external data sources, and optimize responses based on user input and system feedback.

The systems and methods described herein provide a novel approach for generating, managing, and optimizing agentic frameworks and the agents within them, which leverage generative models to perform complex tasks. Generative AI systems may operate as standalone models, responding to user queries without structured planning or iterative refinement. While these models have demonstrated impressive generative capabilities, they lack the features and benefits of an agentic framework. An agentic framework enables dynamic task orchestration, multi-step reasoning, and collaborative agent interaction, improving task efficiency, adaptability, and performance in complex, multi-modal environments. For example, an agentic framework could allow a system to combine text-based and image-based inputs to generate richer outputs or enable agents to iteratively refine responses based on real-time feedback, improving the accuracy and relevance of results. An example agentic framework can be as described in U.S. Pat. No. 12,111,859 issued Oct. 8, 2024, Ser. No. 18/542,536 with priority to Dec. 16, 2022 titled Unbounded Data Model Query Handling and Dispatching Actions in a Model Driven Architecture by C3 AI, Inc which is hereby incorporated by refence.

Existing approaches to building agentic frameworks can require extensive manual configuration, including defining agent behavior logic, specifying execution constraints, and implementing communication mechanisms that allow agents to interact effectively. Some frameworks demand explicit programming of decision-making rules, requiring developers to structure workflows that dictate how agents collaborate, retrieve information, and process tasks. Another challenge in generating agentic frameworks is the integration of generative models that support adaptive decision-making and iterative refinement. Conventional architectures often rely on static agent behaviors, where predefined rules govern task execution without the flexibility to adjust based on contextual inputs or learned preferences. Configuring agents to work with high-complexity machine learning models introduces additional difficulties, such as selecting appropriate strategies, managing computational overhead, and ensuring that model outputs align with system objectives. Some implementations require developers to manually define how models are accessed, how outputs are validated, and how agents adapt to new information over time. Furthermore, the developers responsible for these tasks may be less familiar with the requirements of a particular framework than the user of the framework. Many enterprise processes are embedded with tacit institutional knowledge that may be difficult and time-consuming to extract and operationalize. Additionally, enterprises operate with vast private datasets spanning multiple modalities, as well as proprietary tools.

Well-designed agentic frameworks still depend heavily on the quality of the underlying tooling. If the tools an agent relies on are unreliable, overly complex, or lack essential functionality, the framework will fail to provide the desired result regardless of its design. Because of this reliance on the quality of the underlying tooling, enterprise development teams must simultaneously maintain and refine agentic frameworks while also developing new tools that these frameworks require. This split focus may lead to delays in both areas and affect quality.

The disclosed system addresses these limitations by providing a scalable tiny agent fine-tuning framework (STAFF), which automatically generates an agentic framework, including the agents within that framework. This agentic framework organizes and governs the behavior and dynamic evolution and self-improvement of agents that independently or collaboratively interact with machine learning models, retrieve and process information, and execute tasks in an adaptive and context-aware manner. Each agent may be generated with a specific role, enabling it to perform specialized functions such as task decomposition, response refinement, external tool integration, or decision-making.

The disclosed system allows business and process users to directly specify their needs in natural language, eliminating the need for developer input and simplifying the capture of institutional knowledge. It then automatically translates these requirements into a fully functional multi-agent framework, reducing reliance on development teams using a specification-to-agentic framework translation agent. The result is an automated process for delivering tailor-made efficient agents. A user that is familiar with a business process that may benefit from automation but has no experience with agents, AI technology, or software development may interact with the system in a conversational manner to describe the requirements, and the system will generate an agentic framework to match the desired process. Agents will use organizational data, existing tools, APIs, and other available information to generate a set of agents that work together to automate the process. The user may then continue to refine the framework by providing feedback in the same conversational manner. In addition, the system will self-refine by identifying opportunities to use less complex LLMs for performance of certain agent tasks.

The system creates a multi-agent structure capable of autonomous planning, memory retention, and tool utilization. The agentic framework is dynamically generated based on predefined criteria, user needs, or environmental conditions. A user need only enter a prompt that indicates the various functions to perform and the tools be used, and the system generates an agentic framework. The system defines the role/persona associated with each agent, and assigns one or more machine learning models to agents based on the information provided by the user. This agentic AI framework analyzes the intended use case, objectives, and operational constraints. Based on this analysis, the system defines an optimal agentic structure, including the number and types of agents required. A specification-to-evaluation metrics agent translation is performed to ensure that metrics for determining accuracy and performance is performed. These metrics are then used to judge the effectiveness of various aspects of the system. This seamless automation reduces the burden on enterprise development teams, allowing them to focus on building essential tooling that enhances efficiency, automation and integration across business processes. The system also addresses computational, latency, and operational constraints by identifying opportunities to use lower-complexity models.

Each agent is instantiated with a specific function, decision-making capability, and access to relevant tools or APIs. Some agents may focus on knowledge retrieval, while others specialize in evaluating and validating generated content, ensuring accuracy and coherence. Some agents are generators of content, leveraging generative technologies. Other agents are critics that review and provide critiques for generated content, assisting in iterative improvement and training.

Once the agentic framework and its agents are generated, the system provides mechanisms for ongoing management and optimization. This includes monitoring agent activity, dynamically adjusting workflows based on real-time performance metrics, and reconfiguring agent behaviors as needed. The system may employ reinforcement learning, rule-based heuristics, or other adaptive techniques to improve agent efficiency over time.

Agents often rely on large or commercial LLMs. Although high-complexity generative models may seem ideal due to their ability to produce high-quality, contextually rich outputs, there are several reasons for incorporating less complex models within an agentic framework. However, enterprise constraints such as cost, latency, security, or offline deployment may require a more tailored approach. High-complexity models require significant computational resources, making them impractical for real-time applications where low-latency responses are critical.

The disclosed system supports the dynamic training and deployment of lower-complexity models for use with agents, which reduce inference time and minimize hardware constraints, allowing agents to function efficiently in environments with limited processing power. An agent that uses a lower-complexity model may be referred to as a “tiny” agent. Tiny agents can manage large tasks with an impact similar to an agent associated with a more complex model. However, the use of tiny agents has a variety of advantages. By using less complex models, scalability within agentic frameworks may be improved by distributing tasks based on complexity requirements. Rather than relying on a single high-complexity model for all decisions, the system can offload routine or well-defined tasks to smaller models, reserving high-complexity models for scenarios that require deeper reasoning or nuanced language generation. This approach optimizes resource allocation and reduces overall operational costs and environmental impact.

Another advantage of using less complex models is their improved interpretability. High-complexity models, particularly large-scale neural networks, often function as black boxes with limited transparency into their decision-making processes. Smaller models, in contrast, tend to have more structured and explainable decision paths, making them easier to debug, refine, and align with regulatory or compliance requirements. Training data for lower-complexity models may be mined from enterprise data and interactions with the framework during creation and refinement. Additionally, the system may employs synthetic data generation and distillation recipes to further enhance the model's performance. This ensures that the distilled model retains the necessary reasoning capabilities while aligning with enterprise operational requirements.

Using a mix of high- and low-complexity models also facilitates iterative learning and model distillation. A high-complexity model can generate training data, preference rankings, or decision rationales that a lower-complexity model then learns to approximate. Over time, this approach allows the system to transition certain tasks from expensive models to more efficient alternatives without sacrificing performance.

The disclosed system is effective at distilling an agentic framework based on large or commercial transform based models into a framework based on significantly smaller transformer based models. This is enabled by a novel training architecture and process that results in the use of lower-complexity models for agents, without the need for human intervention during the training process. A lower-complexity model that has been trained using imitation learning or other model training methods may be used for an agent. When in training mode, the agent generates multiple responses to a request. Each of these responses are then analyzed by a validation module that has access to ground-truth data, or by a high-complexity model such as a computationally expensive but highly accurate large language model. The system uses these mechanisms to determine the accuracy of each of the generated responses and provide feedback to the lower-complexity model.

A critic agent is then used to provide a critique of each output created in response to the same request. The critique may include, for example, an interpretation of the reason for the correctness or incorrectness of each generated response. The critic agent may also use a lower complexity model to generate the critiques. The critiques are also sent to the validation module or high-complexity model for accuracy checking. Rewards may be assigned to both generated output and critiques, with rewards indicating that the output or critique may be useful for training the lower-complexity model. Combinations of generated output and critiques that meet a reward threshold are then selected for use as training data.

Optimizing lower-complexity models to approximate the decision-making patterns of high-complexity generative models requires a structured training process that selectively incorporates high-quality outputs. Rather than relying on traditional supervised fine-tuning with manually labeled data, direct preference optimization (DPO) is used. DPO provides an alternative approach by leveraging ranked model generations. Outputs that meet a predefined reward threshold are used for training, ensuring that the lower-complexity model learns from the most preferred responses. DPO facilitates this training process by adjusting model parameters based on comparative rankings rather than explicit reward modeling. Instead of assigning absolute numerical rewards, the system evaluates multiple generated outputs for a given task and ranks them according to predefined quality metrics, such as coherence, factual accuracy, stylistic appropriateness, or task-specific relevance. Outputs that surpass the reward threshold are incorporated into the training set, while lower-ranked outputs are discarded or used as contrastive examples to refine decision boundaries.

This approach enables efficient model adaptation without requiring an extensive manual annotation process. The high-complexity model serves as a reference, generating diverse responses that capture nuanced decision-making behaviors. By selectively training on high-quality responses, the lower-complexity model learns to approximate these behaviors while maintaining lower computational overhead. Over successive training iterations, preference-aligned learning refines the lower-complexity model's ability to generate outputs that consistently meet reward criteria, allowing it to perform specific tasks with reduced latency and resource requirements. DPO also provides a structured mechanism for iterative improvement. As the system continues generating and evaluating outputs, reward thresholds can dynamically adjust based on evolving quality expectations. This enables continual refinement of the lower-complexity model without retraining from scratch, supporting adaptive optimization as task requirements evolve. By leveraging preference-driven training, the system improves efficiency while ensuring that the lower-complexity model retains alignment with the decision-making patterns of the high-complexity reference model.

Although efficiency gains are achieved by training a lower complexity model and then using that model for performance of agent operations instead of a higher complexity model (effectively swapping the higher complexity model for the lower complexity model), additional optimization may be achieved through additional fine tuning. When the system receives the specification from the user indicating the desired framework attributes, an evaluation is performed to identify metrics and attributes that may be used to determine whether the system is functioning both correctly and efficiently. These metrics and attributes are measured to identify potential gaps or opportunities.

For example, the system may identify a performance gap that may be remedied by the creation of a new agent that performs a beneficial function or by the creation of a new tool. In some instances, the system will automatically generate code that leverages available data or existing functionality for which a tool does not exist. The tool can be stored for later use within the framework, and may be re-used for other frameworks. Through continued gap analysis, the system may identify new tools that have been subsequently added which may create efficiencies that were not possible during the inception of the framework. The system may then automatically create an agent that leverages such a tool to create a more efficient agentic framework that serves the purposes specified by the user.

One or more embodiments described in this Specification and/or recited in the claims may not be included in this General Overview section.

### Agentic Architecture

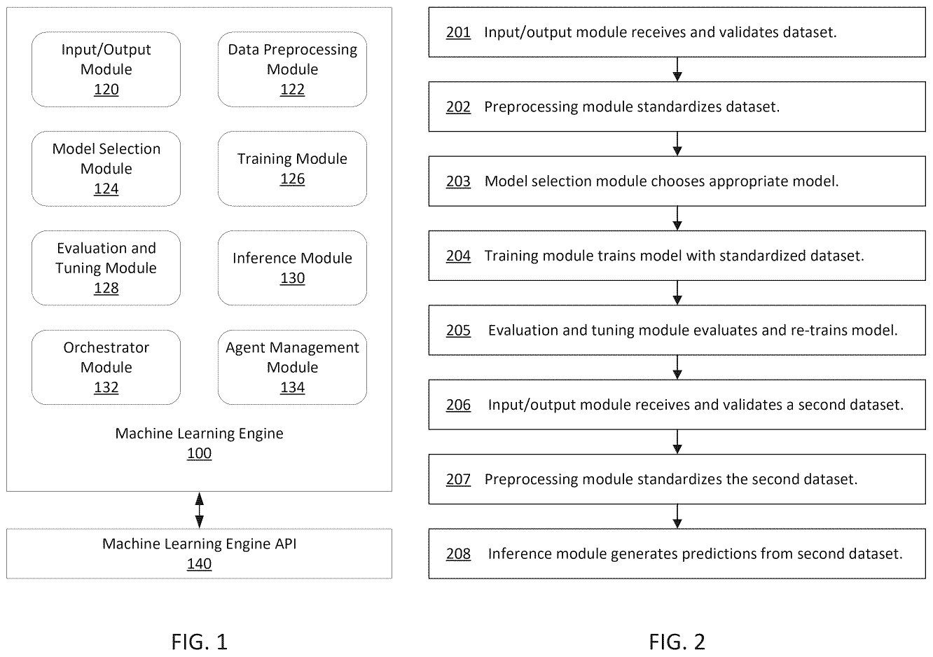

FIG. 1 illustrates a machine learning engine 100 in accordance with one or more embodiments. As illustrated in FIG. 1, machine learning engine 100 includes input/output module 120, data preprocessing module 122, model selection module 124, training module 126, evaluation and tuning module 128, inference module 130, orchestrator module 132, and agent management module 134.

In accordance with an embodiment, input/output module 120 serves as the primary interface for data entering and exiting the system, managing the flow and integrity of data. This module may accommodate a wide range of data sources and formats to facilitate integration and communication within the machine learning architecture.

In an embodiment, an input handler within input/output module 120 includes a data ingestion framework capable of interfacing with various data sources, such as databases, APIs, file systems, and real-time data streams. This framework is equipped with functionalities to handle different data formats (e.g., CSV, JSON, XML) and efficiently manage large volumes of data. It includes mechanisms for batch and real-time data processing that enable the input/output module 120 to be versatile in different operational contexts, whether processing historical datasets or streaming data.

In accordance with an embodiment, input/output module 120 manages data integrity and quality as it enters the system by incorporating initial checks and validations. These checks and validations ensure that incoming data meets predefined quality standards, like checking for missing values, ensuring consistency in data formats, and verifying data ranges and types. This proactive approach to data quality minimizes potential errors and inconsistencies in later stages of the machine learning process.

In an embodiment, an output handler within input/output module 120 includes an output framework designed to handle the distribution and exportation of outputs, predictions, or insights. Using the output framework, input/output module 120 formats these outputs into user-friendly and accessible formats, such as reports, visualizations, or data files compatible with other systems. Input/output module 120 also ensures secure and efficient transmission of these outputs to end-users or other systems in an embodiment and may employ encryption and secure data transfer protocols to maintain data confidentiality.

In accordance with an embodiment, data preprocessing module 122 transforms data into a format suitable for use by other modules in machine learning engine 100. For example, data preprocessing module 122 may transform raw data into a normalized or standardized format suitable for training ML models and for processing new data inputs for inference. In an embodiment, data preprocessing module 122 acts as a bridge between the raw data sources and the analytical capabilities of machine learning engine 100.

In an embodiment, data preprocessing module 122 begins by implementing a series of preprocessing steps to clean, normalize, and/or standardize the data. This involves handling a variety of anomalies, such as managing unexpected data elements, recognizing inconsistencies, or dealing with missing values. Some of these anomalies can be addressed through methods like imputation or removal of incomplete records, depending on the nature and volume of the missing data. Data preprocessing module 122 may be configured to handle anomalies in different ways depending on context. Data preprocessing module 122 also handles the normalization of numerical data in preparation for use with models sensitive to the scale of the data, like neural networks and distance-based algorithms. Normalization techniques, such as min-max scaling or z-score standardization, may be applied to bring numerical features to a common scale, enhancing the model's ability to learn effectively.

In an embodiment, data preprocessing module 122 includes a feature encoding framework that ensures categorical variables are transformed into a format that can be easily interpreted by machine learning algorithms. Techniques like one-hot encoding or label encoding may be employed to convert categorical data into numerical values, making them suitable for analysis. The module may also include feature selection mechanisms, where redundant or irrelevant features are identified and removed, thereby increasing the efficiency and performance of the model.

In accordance with an embodiment, when data preprocessing module 122 processes new data for inference, data preprocessing module 122 replicates the same preprocessing steps to ensure consistency with the training data format. This helps to avoid discrepancies between the training data format and the inference data format, thereby reducing the likelihood of inaccurate or invalid model predictions.

In an embodiment, model selection module 124 includes logic for determining the most suitable algorithm or model architecture for a given dataset and problem. This module operates in part by analyzing the characteristics of the input data, such as its dimensionality, distribution, and the type of problem (classification, regression, clustering, etc.).

In an embodiment, model selection module 124 employs a variety of statistical and analytical techniques to understand data patterns, identify potential correlations, and assess the complexity of the task. Based on this analysis, it then matches the data characteristics with the strengths and weaknesses of various available models. This can range from simple linear models for less complex problems to sophisticated deep learning architectures for tasks requiring feature extraction and high-level pattern recognition, such as image and speech recognition.

In an embodiment, model selection module 124 utilizes techniques from the field of Automated Machine Learning (AutoML). AutoML systems automate the process of model selection by rapidly prototyping and evaluating multiple models. They use techniques like Bayesian optimization, genetic algorithms, or reinforcement learning to explore the model space efficiently. Model selection module 124 may use these techniques to evaluate each candidate model based on performance metrics relevant to the task. For example, accuracy, precision, recall, or F1 score may be used for classification tasks and mean squared error metrics may be used for regression tasks. Accuracy measures the proportion of correct predictions (both positive and negative). Precision measures the proportion of actual positives among the predicted positive cases. Recall (also known as sensitivity) evaluates how well the model identifies actual positives. F1 Score is a single metric that accounts for both false positives and false negatives. The mean squared error (MSE) metric may be used for regression tasks. MSE measures the average squared difference between the actual and predicted values, providing an indication of the model's accuracy. A lower MSE may indicate a model's greater accuracy in predicting values, as it represents a smaller average discrepancy between the actual and predicted values.

In accordance with an embodiment, model selection module 124 also considers computational efficiency and resource constraints. This is meant to help ensure the selected model is both accurate and practical in terms of computational and time requirements. In an embodiment, certain features of model selection module 124 are configurable such as a configured bias toward (or against) computational efficiency.

In accordance with an embodiment, training module 126 manages the ‘learning’ process of ML models by implementing various learning algorithms that enable models to identify patterns and make predictions or decisions based on input data. In an embodiment, the training process begins with the preparation of the dataset after preprocessing; this involves splitting the data into training and validation sets. The training set is used to teach the model, while the validation set is used to evaluate its performance and adjust parameters accordingly. Training module 126 handles the iterative process of feeding the training data into the model, adjusting the model's internal parameters (like weights in neural networks) through backpropagation and optimization algorithms, such as stochastic gradient descent or other algorithms providing similarly useful results.

In accordance with an embodiment, training module 126 manages overfitting, where a model learns the training data too well, including its noise and outliers, at the expense of its ability to generalize to new data. Techniques such as regularization, dropout (in neural networks), and early stopping are implemented to mitigate this. Additionally, the module employs various techniques for hyperparameter tuning; this involves adjusting model parameters that are not directly learned from the training process, such as learning rate, the number of layers in a neural network, or the number of trees in a random forest.

In an embodiment, training module 126 includes logic to handle different types of data and learning tasks. For instance, it includes different training routines for supervised learning (where the training data comes with labels) and unsupervised learning (without labeled data). In the case of deep learning models, training module 126 also manages the complexities of training neural networks that include initializing network weights, choosing activation functions, and setting up neural network layers.

In an embodiment, evaluation and tuning module 128 incorporates dynamic feedback mechanisms and facilitates continuous model evolution to help ensure the system's relevance and accuracy as the data landscape changes. Evaluation and tuning module 128 conducts a detailed evaluation of a model's performance. This process involves using statistical methods and a variety of performance metrics to analyze the model's predictions against a validation dataset. The validation dataset, distinct from the training set, is instrumental in assessing the model's predictive accuracy and its capacity to generalize beyond the training data. The module's algorithms meticulously dissect the model's output, uncovering biases, variances, and the overall effectiveness of the model in capturing the underlying patterns of the data.

In an embodiment, evaluation and tuning module 128 performs continuous model tuning by using hyperparameter optimization. Evaluation and tuning module 128 performs an exploration of the hyperparameter space using algorithms, such as grid search, random search, or more sophisticated methods like Bayesian optimization. Evaluation and tuning module 128 uses these algorithms to iteratively adjust and refine the model's hyperparameters-settings that govern the model's learning process but are not directly learned from the data-to enhance the model's performance. This tuning process helps to balance the model's complexity with its ability to generalize and attempts to avoid the pitfalls of underfitting or overfitting.

In an embodiment, evaluation and tuning module 128 integrates data feedback and updates the model. Evaluation and tuning module 128 actively collects feedback from the model's real-world applications, an indicator of the model's performance in practical scenarios. Such feedback can come from various sources depending on the nature of the application. For example, in a user-centric application like a recommendation system, feedback might comprise user interactions, preferences, and responses. In other contexts, such as predicting events, it might involve analyzing the model's prediction errors, misclassifications, or other performance metrics in live environments.

In an embodiment, feedback integration logic within evaluation and tuning module 128 integrates this feedback using a process of assimilating new data patterns, user interactions, and error trends into the system's knowledge base. The feedback integration logic uses this information to identify shifts in data trends or emergent patterns that were not present or inadequately represented in the original training dataset. Based on this analysis, the module triggers a retraining or updating cycle for the model. If the feedback suggests minor deviations or incremental changes in data patterns, the feedback integration logic may employ incremental learning strategies, fine-tuning the model with the new data while retaining its previously learned knowledge. In cases where the feedback indicates significant shifts or the emergence of new patterns, a more comprehensive model updating process may be initiated. This process might involve revisiting the model selection process, re-evaluating the suitability of the current model architecture, and/or potentially exploring alternative models or configurations that are more attuned to the new data.

In accordance with an embodiment, throughout this iterative process of feedback integration and model updating, evaluation and tuning module 128 employs version control mechanisms to track changes, modifications, and the evolution of the model, facilitating transparency and allowing for rollback if necessary. This continuous learning and adaptation cycle, driven by real-world data and feedback, helps to endure the model's ongoing effectiveness, relevance, and accuracy.

In an embodiment, inference module 130 transforms raw data into actionable, precise, and contextually relevant predictions. In addition to processing and applying a trained model to new data, inference module 130 may also include post-processing logic that refines the raw outputs of the model into meaningful insights.

In an embodiment, inference module 130 includes classification logic that takes the probabilistic outputs of the model and converts them into definitive class labels. This process involves an analytical interpretation of the probability distribution for each class. For example, in binary classification, the classification logic may identify the class with a probability above a certain threshold, but classification logic may also consider the relative probability distribution between classes to create a more nuanced and accurate classification.

In an embodiment, inference module 130 transforms the outputs of a trained model into definitive classifications. Inference module 130 employs the underlying model as a tool to generate probabilistic outputs for each potential class. It then engages in an interpretative process to convert these probabilities into concrete class labels.

In an embodiment, when inference module 130 receives the probabilistic outputs from the model, it analyzes these probabilities to determine how they are distributed across some or every potential class. If the highest probability is not significantly greater than the others, inference module 130 may determine that there is ambiguity or interpret this as a lack of confidence displayed by the model.

In an embodiment, inference module 130 uses thresholding techniques for applications where making a definitive decision based on the highest probability might not suffice due to the critical nature of the decision. In such cases, inference module 130 assesses if the highest probability surpasses a certain confidence threshold that is predetermined based on the specific requirements of the application. If the probabilities do not meet this threshold, inference module 130 may flag the result as uncertain or defer the decision to a human expert. Inference module 130 dynamically adjusts the decision thresholds based on the sensitivity and specificity requirements of the application, subject to calibration for balancing the trade-offs between false positives and false negatives.

In accordance with an embodiment, inference module 130 contextualizes the probability distribution against the backdrop of the specific application. This involves a comparative analysis, especially in instances where multiple classes have similar probability scores, to deduce the most plausible classification. In an embodiment, inference module 130 may incorporate additional decision-making rules or contextual information to guide this analysis, ensuring that the classification aligns with the practical and contextual nuances of the application.

In regression models, where the outputs are continuous values, inference module 130 may engage in a detailed scaling process in an embodiment. Outputs, often normalized or standardized during training for optimal model performance, are rescaled back to their original range. This rescaling involves recalibration of the output values using the original data's statistical parameters, such as mean and standard deviation, ensuring that the predictions are meaningful and comparable to the real-world scales they represent.

In an embodiment, inference module 130 incorporates domain-specific adjustments into its post-processing routine. This involves tailoring the model's output to align with specific industry knowledge or contextual information. For example, in financial forecasting, inference module 130 may adjust predictions based on current market trends, economic indicators, or recent significant events, ensuring that the outputs are both statistically accurate and practically relevant.

In an embodiment, inference module 130 includes logic to handle uncertainty and ambiguity in the model's predictions. In cases where inference module 130 outputs a measure of uncertainty, such as in Bayesian inference models, inference module 130 interprets these uncertainty measures by converting probabilistic distributions or confidence intervals into a format that can be easily understood and acted upon. This provides users with both a prediction and an insight into the confidence level of that prediction. In an embodiment, inference module 130 includes mechanisms for involving human oversight or integrating the instance into a feedback loop for subsequent analysis and model refinement.

In an embodiment, inference module 130 formats the final predictions for end-user consumption. Predictions are converted into visualizations, user-friendly reports, or interactive interfaces. In some systems, like recommendation engines, inference module 130 also integrates feedback mechanisms, where user responses to the predictions are used to continually refine and improve the model, creating a dynamic, self-improving system.

FIG. 2 illustrates the operation of a machine learning engine in one or more embodiments. In an embodiment, input/output module 120 receives a dataset intended for training (Operation 201). This data can originate from diverse sources, like databases or real-time data streams, and in varied formats, such as CSV, JSON, or XML. Input/output module 120 assesses and validates the data, ensuring its integrity by checking for consistency, data ranges, and types.

In an embodiment, training data is passed to data preprocessing module 122. Here, the data undergoes a series of transformations to standardize and clean it, making it suitable for training ML models (Operation 202). This involves normalizing numerical data, encoding categorical variables, and handling missing values through techniques like imputation.

In an embodiment, prepared data from the data preprocessing module 122 is then fed into model selection module 124 (Operation 203). This module analyzes the characteristics of the processed data, such as dimensionality and distribution, and selects the most appropriate model architecture for the given dataset and problem. It employs statistical and analytical techniques to match the data with an optimal model, ranging from simpler models for less complex tasks to more advanced architectures for intricate tasks.

In an embodiment, training module 126 trains the selected model with the prepared dataset (Operation 204). It implements learning algorithms to adjust the model's internal parameters, optimizing them to identify patterns and relationships in the training data. Training module 126 also addresses the challenge of overfitting by implementing techniques, like regularization and early stopping, ensuring the model's generalizability.

In an embodiment, evaluation and tuning module 128 evaluates the trained model's performance using the validation dataset (Operation 205). Evaluation and tuning module 128 applies various metrics to assess predictive accuracy and generalization capabilities. It then tunes the model by adjusting hyperparameters, and if needed, incorporates feedback from the model's initial deployments, retraining the model with new data patterns identified from the feedback.

In an embodiment, input/output module 120 receives a dataset intended for inference. Input/output module 120 assesses and validates the data (Operation 206).

In an embodiment, data preprocessing module 122 receives the validated dataset intended for inference (Operation 207). Data preprocessing module 122 ensures that the data format used in training is replicated for the new inference data, maintaining consistency and accuracy for the model's predictions.

In an embodiment, inference module 130 processes the new data set intended for inference, using the trained and tuned model (Operation 208). It applies the model to this data, generating raw probabilistic outputs for predictions. Inference module 130 then executes a series of post-processing steps on these outputs, such as converting probabilities to class labels in classification tasks or rescaling values in regression tasks. It contextualizes the outputs as per the application's requirements, handling any uncertainty in predictions and formatting the final outputs for end-user consumption or integration into larger systems.

In an embodiment, orchestrator module 132 manages the execution of tasks within machine learning engine 100 by coordinating the assignment and execution of tasks among various agents, including inference agents, data processing agents, and specialized agents tailored to specific data modalities and task types. Orchestrator module 132 functions as the central control unit of the machine learning engine, analyzing the nature and complexity of each task and determining the most effective strategy for execution. This includes evaluating the data structure, task priority, and system load to select an optimal combination of agents and processing pipelines. Orchestrator module 132 processes both structured data (e.g., relational databases) and unstructured data (e.g., text, audio, and images), transforming the data into a common format suitable for processing by downstream agents.

In an embodiment, orchestrator module 132 includes an input analysis framework that evaluates the structure, format, and content of incoming tasks to determine the type of processing required. For example, text-based inputs may require tokenization and language model-based processing, whereas image-based inputs may require convolutional or transformer-based processing. The input analysis framework may extract metadata from inputs, such as timestamps, entity tags, and embedded formats, to enhance task classification and routing. Orchestrator module 132 includes a normalization layer that standardizes data across different sources and formats, ensuring consistent preprocessing by downstream agents. For example, time-series data may be normalized to a consistent sampling rate, and image data may be resized or reformatted to match the input dimensions expected by image processing agents.

Orchestrator module 132 supports task decomposition and dynamic pipeline generation. When presented with a complex, multi-faceted task, orchestrator module 132 decomposes the task into subtasks and assigns them to appropriate agents based on their functional capabilities and current workload. For example, a multimodal task involving audio transcription, text analysis, and image classification may be split into independent subtasks processed by audio processing agents, natural language processing (NLP) agents, and convolutional neural network (CNN) agents. Orchestrator module 132 tracks task dependencies and sequences outputs from upstream agents into the input streams of downstream agents to maintain execution order and data integrity.

Orchestrator module 132 includes a task execution model that leverages machine learning-based and heuristic-based strategies to optimize task routing and execution. The task execution model considers factors such as agent availability, historical performance data, processing latency, and resource consumption to select the most efficient execution strategy. If a high-priority task is introduced while lower-priority tasks are running, orchestrator module 132 may preempt lower-priority tasks, redistribute resources, or modify the execution order to accommodate the new task. For example, if a complex NLP task involving long-form text analysis is running concurrently with a high-priority real-time classification task, orchestrator module 132 may adjust the token limits of the NLP task or reduce the batch size of the classification task to minimize overall latency.

In an embodiment, orchestrator module 132 includes fault-tolerant task execution capabilities. If an agent becomes unresponsive, returns incomplete or erroneous results, or exceeds predefined latency thresholds, orchestrator module 132 may automatically reassign the task to a backup agent or modify the execution strategy to account for reduced system capacity. Orchestrator module 132 may apply weighted confidence thresholds to agent outputs, triggering reprocessing or escalation if the confidence score falls below a predefined limit. For example, if a text classification agent returns a confidence score of 0.6 while the required threshold is 0.8, orchestrator module 132 may invoke a more complex deep learning-based agent to refine the classification result.

In some embodiments, orchestrator module 132 integrates with evaluation and tuning module 128 to incorporate feedback from completed tasks into the task execution model. Performance data, including task completion time, error rates, and resource utilization, are used to adjust task routing parameters and agent selection policies. If a specific agent consistently demonstrates higher accuracy or lower latency for a given task type, orchestrator module 132 may increase the task load allocated to that agent. Conversely, if an agent underperforms or exhibits increased error rates, orchestrator module 132 may trigger agent retraining through agent management module 134 or reduce the task load assigned to that agent.

Orchestrator module 132 also supports context-aware task execution. For example, if an agent is handling a speech-to-text task involving specialized terminology from a medical or legal domain, orchestrator module 132 may route the task to a domain-specific NLP agent trained on relevant vocabulary and context. Similarly, if an image classification task involves identifying geological formations, orchestrator module 132 may select a convolutional neural network trained on geological datasets. This domain-aware task routing capability enhances task accuracy and relevance across a wide range of application contexts.

In some embodiments, orchestrator module 132 may perform certain inference-related tasks typically handled by inference module 130. For example, orchestrator module 132 may apply pre-trained models directly to input data when specialized inference agents are unavailable or overloaded. This enables orchestrator module 132 to provide a fallback mechanism for real-time classification or prediction tasks without requiring agent involvement. For instance, if inference module 130 is under heavy load, orchestrator module 132 may apply a lightweight model to generate a preliminary result, which is subsequently refined by inference module 130 when resources become available.

In an embodiment, agent management module 134 governs the lifecycle, state, and operational efficiency of agents within machine learning engine 100. Agent management module 134 functions as the central resource allocator, dynamically instantiating, configuring, and terminating agents based on task volume, system load, and agent performance metrics. If system load increases, agent management module 134 may allocate additional CPU, GPU, or memory resources to active agents or instantiate new agent instances to handle the increased demand. Conversely, during periods of low task volume, agent management module 134 may terminate idle agents or reduce resource allocation to conserve processing capacity and minimize operational costs.

Agent management module 134 monitors agent health and performance using real-time telemetry data, including task completion time, error rates, resource consumption, and communication latency. If an agent exceeds predefined thresholds for latency, memory usage, or task error rates, agent management module 134 may modify the agent's configuration, increase resource allocation, or initiate retraining. For example, if a CNN-based image processing agent experiences increased processing time due to large input size, agent management module 134 may increase GPU allocation or adjust batch processing parameters to optimize performance.

In an embodiment, agent management module 134 includes a failure recovery framework that handles agent crashes and unresponsiveness. If an agent becomes unresponsive or fails to produce an expected output within a predefined time window, agent management module 134 may isolate the failure, reset the agent, and reassign the task to a backup agent. For stateful agents, agent management module 134 may preserve intermediate processing states and reload them into a new agent instance to minimize processing loss and maintain task continuity. If an agent failure results from a model configuration error, agent management module 134 may trigger a rollback to a previous stable version of the agent or initiate a reconfiguration cycle.

Agent management module 134 supports dynamic agent scaling and load balancing. If multiple agents of the same type are available, agent management module 134 distributes tasks among agents to prevent processing bottlenecks and optimize throughput. In some cases, agent management module 134 may assign specific agents to task types based on domain expertise. For example, if an NLP agent trained on financial data and another NLP agent trained on medical data are both available, agent management module 134 may route financial documents to the finance-trained agent and medical transcripts to the medical-trained agent.

Agent management module 134 integrates with evaluation and tuning module 128 to continuously refine agent performance and configuration. Performance data, including accuracy, latency, and resource usage, are used to adjust agent training parameters and selection policies. If an agent consistently outperforms others for a given task type, agent management module 134 may increase the task load allocated to that agent. Conversely, if an agent exhibits increased error rates or reduced accuracy, agent management module 134 may initiate retraining, reconfiguration, or replacement of the agent model.

In an embodiment, agent management module 134 includes domain-specific agent instantiation logic. If a task requires specialized processing, such as medical image analysis or financial data modeling, agent management module 134 may instantiate an agent trained on domain-specific data or models. For example, if a radiology dataset is submitted for analysis, agent management module 134 may allocate additional GPU resources and instantiate a CNN-based agent pre-trained on medical imaging datasets to enhance accuracy and processing speed.

In an embodiment, the functions of orchestrator module 132 and agent management module 134 may be distributed across additional modules or subsystems to support higher scalability or functional specialization. For example, task routing and load balancing may be managed by a dedicated task distribution module, while agent instantiation and health monitoring may be handled by a separate resource management module. In some configurations, orchestrator module 132 may delegate multimodal processing to a dedicated multimodal processing module that integrates inputs from audio, text, and image streams. Similarly, agent management module 134 may offload fault detection and recovery to a specialized monitoring module designed to handle agent-level failures and resource reallocation.

In an embodiment, the architecture is designed to be generalized and modular, supporting the addition or removal of modules based on system requirements. A version of the architecture may include an orchestrator module to manage task execution across agents, while another version may omit the orchestrator module but retain the inference module for direct model interaction. Similarly, the inference module can be configured to work with a range of LLMs and generative models, depending on the task. This modular structure allows the architecture to scale and adapt to different operational contexts without requiring a redesign.

In some configurations, the orchestrator module may manage multiple agents, each of which can be associated with a different LLM or generative model. For example, one agent may leverage a large language model optimized for natural language processing tasks, while another agent may use a multimodal model to handle image and audio data. Each agent's underlying LLM may have its own inference module and training pipeline, tailored to the type of input data and task complexity. This enables the architecture to orchestrate complex, multi-step workflows that involve different types of data and model outputs.

In an embodiment, the system may dynamically adjust which modules are active based on the task requirements and system constraints. For example, in a resource-constrained environment, the orchestrator module may offload certain tasks to specific agents or bypass certain modules to conserve computational resources. Likewise, if a specific agent's LLM produces higher-confidence outputs in certain contexts, the orchestrator may prioritize that agent's inference module for those tasks. This dynamic configuration allows the architecture to optimize performance while maintaining the flexibility to incorporate new models or remove underperforming ones.

The modular nature of the architecture also facilitates model-specific configurations at the agent level. An agent using a transformer-based model may require specific tokenization, attention head configurations, and scaling factors, while an agent using a convolutional model may require different preprocessing and post-processing pipelines. The orchestrator module can integrate these varying requirements, ensuring that each agent functions within its optimal parameters while coordinating outputs from different models into a unified result.

In an embodiment, machine learning engine API 140 allows for applications to leverage machine learning engine 100. In an embodiment, machine learning engine API 140 may be built on a RESTful architecture and offer stateless interactions over standard HTTP/HTTPS protocols. Machine learning engine API 140 may feature a variety of endpoints, each tailored to a specific function within machine learning engine 100. In an embodiment, endpoints such as/submitData facilitate the submission of new data for processing, while/retrieveResults is designed for fetching the outcomes of data analysis or model predictions. The MLE API may also include endpoints like/updateModel for model modifications and/trainModel to initiate training with new datasets.

In an embodiment, machine learning engine API 140 is equipped to support SOAP-based interactions. This extension involves defining a WSDL (Web Services Description Language) document that outlines the API's operations and the structure of request and response messages. In an embodiment, machine learning engine API 140 supports various data formats and communication styles. In an embodiment, machine learning engine API 140 endpoints may handle requests in JSON format or any other suitable format. For example, machine learning engine API 140 may process XML, and it may also be engineered to handle more compact and efficient data formats, such as Protocol Buffers or Avro, for use in bandwidth-limited scenarios.

In an embodiment, machine learning engine API 140 is designed to integrate WebSocket technology for applications necessitating real-time data processing and immediate feedback. This integration enables a continuous, bi-directional communication channel for a dynamic and interactive data exchange between the application and machine learning engine 100.

### Generative Models

A generative model is a machine learning model that is capable of generating new data instances based on the data used to train the model. A generative model may be referred to as a “generative artificial intelligence (AI) model.” Generative models learn the underlying distribution of the training data, enabling them to produce new instances of data that share properties with the original dataset. This capability makes them particularly useful in a variety of applications, including image and voice generation, text synthesis, and more sophisticated tasks like unsupervised learning, semi-supervised learning, and domain adaptation.

One type of generative model is a large language model. Large language models are designed to understand, generate, and interpret human language by processing extensive collections of data. The foundational architecture behind large language models is the transformer network, a type of neural network that excels in handling sequential data such as text. Unlike architectures, such as recurrent neural networks (RNNs) or long short-term memory networks (LSTMs), transformers do not process data in order. Instead, they leverage parallel processing to analyze entire text sequences simultaneously, significantly improving efficiency and reducing training times.

In an embodiment, a mechanism that enables transformers to handle complex language tasks is self-attention. This mechanism allows the model to weigh the importance of different words within a sentence or sequence regardless of their position. For instance, in processing the phrase “The cat sat on the mat,” the model can directly associate “cat” with “mat” without having to process the intermediate words sequentially. This ability to understand the context and relationships between words in a sentence is what makes transformer networks adept at language tasks. The self-attention mechanism assigns scores to relationships between words, highlighting the most relevant connections, so the model can focus on the most informative parts of the text.

In accordance with one or more embodiments, transformers are composed of multiple layers containing a multi-head, self-attention mechanism and a position-wise, feed-forward network. Within the architecture of transformer models, the multi-head, self-attention mechanism and position-wise, feed-forward network function in concert to process input data. The multi-head, self-attention mechanism is designed to enable parallel processing of input sequences, allowing the model to simultaneously evaluate the importance of different segments of the input relative to each other. This mechanism operates by generating multiple sets of query, key, and value vectors for each element in the input sequence through linear transformation. The relevance of each element to every other element is calculated using a scaled dot-product attention function that computes the attention scores by taking the dot product of the query vector with the key vectors, dividing each by the square root of the dimension of the key vectors to scale the scores, then applying a softmax function to obtain the weights for the value vectors. The scaled dot-product attention function is applied independently by each head in the multi-head self-attention mechanism. The outputs of these heads are then concatenated and linearly transformed, allowing the model to capture information from different representation subspaces.

In accordance with one or more embodiments, following the multi-head, self-attention mechanism is the position-wise, feed-forward network. This component comprises two linear transformations with a non-linear activation function in between. Each element of the input sequence, now enriched with context by the self-attention mechanism, is processed independently through the same feed-forward network. The first linear transformation increases the dimensionality of the input, allowing for a richer representation space. The non-linear activation function introduces the capability to capture non-linear relationships within the data. The second linear transformation then reduces the dimensionality back to that of the model's hidden layers, preparing the output for either further processing by subsequent layers or final output generation. This sequence of operations is applied to each position in the sequence, so the model can learn complex patterns across different parts of the input data without relying on the sequential processing inherent to previous architectures, such as RNNs or LSTMs.

In accordance with one or more embodiments, integrating these components within the transformer architecture facilitates the model's ability to understand and generate human language by leveraging both the global context provided by the self-attention mechanism and the local, position-specific transformations applied by the feed-forward networks. Through the repetitive stacking of layers, transformers achieve a depth of representation that allows for the processing of linguistic information across varying levels of complexity.

In accordance with one or more embodiments, input/output module 120, when used for large language models, handles textual data, converting input text into a format that the model can process. This typically involves tokenization, where the text is broken down into manageable pieces, such as words or subwords, and then converted into numerical representations. These representations, or embeddings, capture semantic information about the text that is then fed into the model for processing. The output from the model is converted from numerical form back into human-readable text, following the generation of predictions or responses.

In accordance with one or more embodiments, data preprocessing module 122 in the context of large language models may include steps such as normalization, where the text is converted to a uniform case and punctuation is standardized. This process ensures that the model treats similar words or symbols consistently, reducing the complexity of the input space. Additionally, techniques such as sentence segmentation may be applied to manage longer texts, enabling the model to process information in chunks that align with natural language structures.

In accordance with one or more embodiments, model selection module 124, when used for large language models involves choosing a specific architecture and configuration that is best suited to the task at hand. This decision is based on various factors, such as the size of the available training data, the complexity of the language tasks to be performed, and computational resource constraints. Models may vary in size from millions to billions of parameters, with larger models generally capable of more nuanced language understanding and generation but requiring significantly more computational power to train and operate.

In accordance with one or more embodiments, training module 126, when used for large language models, is configured to adjust the model's parameters through exposure to training data. This process utilizes optimization algorithms, such as stochastic gradient descent, to minimize the difference between the model's predictions and the actual desired outputs. The training process is computationally intensive, often requiring specialized hardware such as GPUs (Graphics Processing Units) or TPUs (Tensor Processing Units) to manage the large volumes of data and the complexity of the model calculations. During training, techniques, such as dropout and layer normalization, are used to improve model generalization and prevent overfitting (i.e., when a model learns the detail and noise in the training data to the extent that it negatively impacts the model's performance on new data).

In accordance with one or more embodiments, evaluation and tuning module 128 assesses the performance of large language models using metrics such as perplexity, accuracy, and F1 score, depending on the specific language tasks. Evaluation may involve comparing the model's output against a set of labeled validation data, providing insight into how well the model has learned to perform tasks, such as text classification, question answering, or text generation. Tuning involves adjusting model parameters or training strategies based on evaluation outcomes to improve performance. This may include hyperparameter tuning, where parameters that govern the training process, such as learning rate or batch size, are adjusted.

In accordance with one or more embodiments, inference module 130, in the context of large language models, is responsible for generating predictions or responses based on new, unseen data. This process involves feeding the input data through the trained model to produce an output. Inference can be used for a variety of applications, including translating text, generating human-like responses in a chatbot, or summarizing articles.

Another type of generative model is a large multimodal model (LMM). A large multimodal model is an advanced machine learning model capable of processing and generating data across multiple modalities, such as text, images, audio, and video. These models integrate diverse datasets during training to learn the underlying distribution of different data types, enabling them to produce outputs that reflect a comprehensive understanding of the input data. These models can be used for applications such as image captioning, text-to-image generation, image-to-text generation, visual question answering, and more, where understanding the relationship between different data types is crucial. By leveraging diverse datasets during training, large multimodal models learn to create coherent and contextually relevant outputs across various modalities, enhancing their utility in complex, real-world scenarios.

The architecture of large multimodal models combines elements from different neural network designs to handle diverse data types effectively. For example, convolutional neural networks (CNNs) are often used for processing visual data, while transformer networks handle textual data, enabling the model to extract and synthesize features from both images and text. This integration results in outputs that accurately represent the input data, reflecting a deep understanding of both modalities. The transformer architecture, known for its ability to manage sequential data, is frequently adapted to work alongside CNNs, allowing these models to benefit from the strengths of each neural network type.

The self-attention mechanism, which is part of a transformer network, enables the model to weigh the importance of different elements within an input sequence, regardless of their position. This allows the model to capture intricate relationships between various data types. For example, in an image captioning task, the model can associate specific visual features with corresponding descriptive text, enhancing the coherence and accuracy of the generated captions. By assigning scores to relationships between elements, the self-attention mechanism highlights the most relevant connections, enabling the model to focus on the most informative parts of the input data and perform complex multimodal tasks effectively.

In large multimodal models, data preprocessing is a step that ensures the input data is in a suitable format for the model to process. This involves tasks such as tokenization for text data, where the text is broken down into manageable pieces, and feature extraction for image data, where key visual elements are identified and encoded. By standardizing and normalizing different data types, preprocessing reduces the complexity of the input space, enabling the model to treat similar elements consistently. Effective preprocessing is essential for the model to integrate information from various modalities and produce accurate, meaningful outputs.

Training large multimodal models involves optimizing their parameters through exposure to diverse datasets that include paired data from different modalities. This computationally intensive process often requires specialized hardware like GPUs or TPUs to manage the large volumes of data and the complexity of the model calculations. A computing system may use GPUs to support the execution of artificial intelligence (AI) models for parallel processing capabilities. A GPU comprises thousands of cores that can perform operations concurrently, allowing large-scale matrix multiplications and tensor computations that are common in AI models to be processed more efficiently compared to a central processing unit (CPU). The GPU architecture is designed to handle multiple threads simultaneously, which supports the parallel execution of numerous small, independent tasks required for training and inference of neural networks.

Neural network training systems may offload matrix multiplication and tensor operations to a GPU due to the GPU's ability to process large batches of data concurrently. Neural networks require the computation of gradients, backpropagation, and optimization steps across potentially millions of parameters. A GPU comprises a high memory bandwidth and a large number of cores that support the simultaneous execution of these operations. The memory architecture of a GPU supports fast data transfer between shared memory and cores, which reduces bottlenecks during matrix and tensor operations.

Techniques such as dropout and layer normalization are employed to improve model generalization and prevent overfitting. By iteratively adjusting the model's parameters, the training process enables the model to learn underlying patterns and relationships within the data, enhancing its ability to generate coherent and contextually relevant outputs across different modalities.

Evaluation and tuning of large multimodal models are conducted using various metrics tailored to the specific tasks they are designed to perform. For example, BLEU scores are used for text generation tasks, while accuracy is commonly applied for visual recognition tasks to assess performance. Tuning involves adjusting hyperparameters and refining training strategies based on evaluation results to enhance the model's effectiveness. This iterative process ensures that the model can perform a wide range of multimodal tasks with high accuracy and relevance, making it a versatile tool for applications requiring the integration of different types of data.

Large multimodal models represent a significant advancement in machine learning by leveraging sophisticated architectures that combine different neural network types and apply self-attention mechanisms. This enables them to perform complex tasks that require understanding and synthesizing information from diverse data types. Effective preprocessing, rigorous training, and thorough evaluation are crucial to their success, allowing these models to generate coherent and contextually relevant outputs across a wide range of applications.

In accordance with one or more embodiments, other types of models besides large language models and large multimodal models belong to the broad category of generative models. For example, stochastic models directly incorporate randomness into their structure, making them inherently generative as they can produce a diverse set of outputs for a given input. Generative Adversarial Networks (GANs) learn to generate new data that is indistinguishable from the data they were trained on, using a dual-network architecture that involves a generative component. Variational Autoencoders (VAEs) are explicitly designed for generating new data points by learning a distribution of the input data and encoding inputs into a latent space and generate outputs by sampling from this space, making them inherently generative. Sequence-to-sequence models are generative in nature when used with sampling strategies. Although this list of generative model types is not exhaustive, it illustrates the broad use of the term generative model beyond large language models.

Although generative models can be leveraged for classification tasks, they inherently operate on principles of randomness, leading to a spectrum of possible outcomes in response to identical inputs. Unlike deterministic models that yield a consistent result whenever the same input is given, generative models use the randomness in the data they are trained on to both mimic and diversify from the training data. This diversity makes generative models ideal for generating new and varied data points as well as for tasks that require creativity and novelty. However, a reliance on randomness creates a trade-off between predictability and flexibility for generative models, potentially making them less predictable in scenarios where uniform outcomes may be expected such as classification tasks.

In an embodiment, supervised fine-tuned learning applies labeled data to adjust pre-trained models for specific tasks. The training module 126 receives a pre-trained model that has undergone initial training on a general dataset, followed by supervised fine-tuning on a task-specific dataset. The training process supports refinement of internal representations by modifying learned weights and biases through backpropagation and optimization algorithms. The data preprocessing module 122 transforms the task-specific dataset to match the format used during the initial pre-training phase, supporting consistency between pre-training and fine-tuning. Preprocessing steps involve normalization, standardization, feature encoding, and sequence alignment for structured and unstructured data sources. Feature extraction and selection mechanisms apply domain-specific transformations to maximize model interpretability and generalization.

In an embodiment, data augmentation techniques support supervised fine-tuned learning by generating task-specific variations of labeled data. The data preprocessing module 122 applies transformations, such as random cropping, rotation, scaling, and noise injection for image-based data, while synonym replacement, back-translation, and paraphrasing techniques apply to text-based data. Synthetic data generation methods support fine-tuning scenarios where labeled datasets are sparse, using generative models, such as variational autoencoders and generative adversarial networks, to construct realistic training samples. The model selection module 124 evaluates candidate architectures based on task complexity, input feature dimensionality, and available computational resources, selecting architectures that balance performance and efficiency for fine-tuned learning applications.

In an embodiment, the training module 126 applies supervised learning techniques that support efficient optimization and convergence. Gradient descent variants, such as Adam, RMSprop, and LAMB, adjust model weights based on computed loss values, while adaptive learning rate schedules regulate training stability. Transfer learning methodologies initialize model parameters using pre-trained weights, allowing for accelerated convergence by leveraging previously learned feature representations. Fine-tuning strategies vary based on the dataset and task requirements, with options for freezing lower network layers while optimizing task-specific layers or applying differential learning rates across network components. Regularization techniques, such as dropout, weight decay, and batch normalization, mitigate overfitting and support model generalization across varied data distributions.

In an embodiment, the evaluation and tuning module 128 applies model validation protocols to assess fine-tuned model performance. Cross-validation, k-fold validation, and leave-one-out validation techniques measure model accuracy, precision, recall, and F1 score on held-out datasets. Hyperparameter tuning algorithms, such as grid search, random search, and Bayesian optimization, adjust learning rate, batch size, and architecture hyperparameters to maximize fine-tuning efficiency. Model distillation techniques compress fine-tuned models by transferring knowledge from complex architectures to lightweight models, supporting deployment in resource-constrained environments. The inference module 130 applies the fine-tuned model to new inputs, generating predictions that align with task-specific training objectives while preserving computational efficiency and response latency requirements.

### Agent Management Architecture

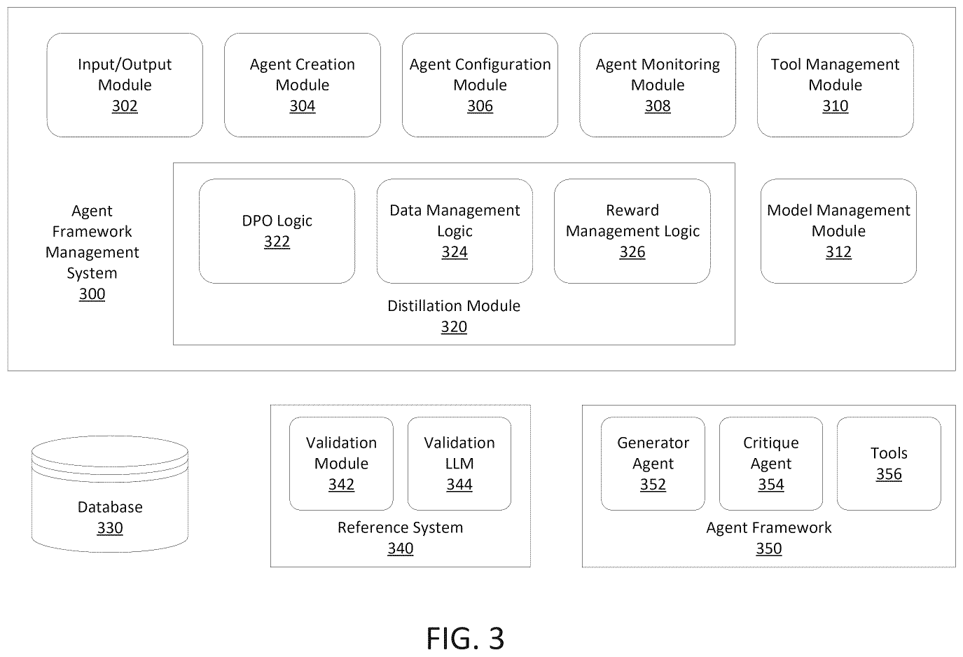

FIG. 3 illustrates an agent framework management system 300 in accordance with one or more embodiments. As illustrated in FIG. 3, agent framework management system 300 includes input/output module 302, agent creation module 304, agent configuration module 306, agent monitoring module 308, tool management module 310, model management module 312, and distillation module 320. Distillation module 320 includes direct preference optimization (DPO) logic 322, data management logic 324, and reward management logic 326. FIG. 3 also illustrates a database 330, reference system 340, and agent framework 350. Reference system 340 includes validation module 342 and validation LLM 344. Agent framework 350 includes generator agent 352, critique agent 354, and tools 356. In one or more embodiments, the agent framework management system 300 may include more or fewer components than the components illustrated in FIG. 3, and may include each of the components illustrated in FIG. 3. The components illustrated in FIG. 3 may be local to or remote from each other. The components illustrated in FIG. 3 may be implemented in software and/or hardware. Each component may be distributed over multiple applications and/or machines. Multiple components may be combined into one application and/or machine. Operations described with respect to one component may instead be performed by another component.

In accordance with one or more embodiments, agent framework management system 300 manages the deployment, execution, and coordination of agents within the machine learning architecture. Agent framework management system 300 supports the definition of agent roles, assigns tasks, and regulates interactions between agents and external components. The system provides an operational framework that governs how agents process inputs, apply learned models, and generate outputs in response to system requirements.

In accordance with an embodiment, agent framework management system 300 applies control policies that regulate agent decision-making processes based on predefined logic, learned behaviors, or real-time input conditions. Task execution mechanisms ensure that agents operate within designated computational constraints, adhere to performance benchmarks, and maintain synchronization with broader system workflows. Agent framework management system 300 applies structured communication protocols to facilitate data exchange between agents and external services, supporting modular and scalable implementations.

In accordance with an embodiment, agent framework management system 300 supports model-driven and rule-based agent behaviors, allowing agents to operate autonomously or in conjunction with human oversight. The system applies monitoring and evaluation mechanisms to track agent performance over time, detect deviations from expected behavior, and trigger corrective actions when necessary. Adaptive learning mechanisms apply feedback-based adjustments to refine agent responses based on evolving operational conditions. The system provides a centralized interface for configuring agent policies, managing updates, and ensuring consistency across distributed deployments.

In accordance with one or more embodiments, input/output module 302 serves as the primary interface for data entering and exiting the agent framework management system 300, managing the flow and integrity of data. This module may accommodate a wide range of data sources and formats to facilitate integration and communication within the system architecture.

In an embodiment, an input handler within input/output module 302 includes a data ingestion framework capable of interfacing with various data sources, such as databases, APIs, file systems, and real-time data streams. This framework is equipped with functionalities to handle different data formats (e.g., CSV, JSON, XML) and efficiently manage large volumes of data. It includes mechanisms for batch and real-time data processing that enable the input/output module 302 to be versatile in different operational contexts, whether processing historical datasets or streaming data.

In accordance with an embodiment, input/output module 302 manages data integrity and quality as it enters the agent framework management system 300 by incorporating initial checks and validations. These checks and validations ensure that incoming data meets predefined quality standards, like checking for missing values, ensuring consistency in data formats, and verifying data ranges and types. This proactive approach to data quality minimizes potential errors and inconsistencies in later stages of the machine learning process.

In an embodiment, an output handler within input/output module 302 includes an output framework designed to handle the distribution and exportation of outputs, predictions, or insights. Using the output framework, input/output module 302 formats output into user-friendly and accessible formats, such as reports, visualizations, or data files compatible with other systems. Input/output module 302 also ensures secure and efficient transmission of these outputs to end-users or other systems in an embodiment and may employ encryption and secure data transfer protocols to maintain data confidentiality.

In accordance with an embodiment, agent creation module 304 instantiates agents with predefined constraints that define their role, execution parameters, and interaction methods. Agent creation module 304 structures an agent framework that governs how agents process data, make decisions, and interact within a system. The module defines whether agents operate independently, coordinate with other agents, or function under a hierarchical control structure. Execution logic determines whether agents perform real-time monitoring, respond to external triggers, or execute tasks in predefined intervals.

In accordance with an embodiment, agent creation module 304 assigns roles (also referred to as personas) that identify or imply the tasks agents perform, the data they process, and the actions they take. Some agents, for example, handle preprocessing, transforming input data before passing it to other components, while others perform inference, apply models, or coordinate workflows. Agent creation module 304 configures agents with role-specific constraints, governing tool access, decision boundaries, and allowable system interactions. Some roles require persistent operation, while others activate only under certain conditions or external commands.

In accordance with an embodiment, agent creation module 304 selects models based on the role and task complexity. Alternatively, agent creation module may take instruction from a user regarding which model to use with one or more agents. Some agents rely on statistical models for structured decision-making, while others apply transformer-based architectures for language processing. Agents may be configured to use any type of model. Agent creation module 304 configures model parameters, adjusting elements such as confidence thresholds, inference temperature, or rule-based logic conditions. Model selection may depend on computational requirements, system latency constraints, or task-specific accuracy needs. In an embodiment, some agents use a single model, while others dynamically switch models or aggregate outputs from multiple models to refine decisions.

In accordance with an embodiment, agent creation module 304 configures agents with access to tools, APIs, and external data sources that support task execution. The module integrates function-calling mechanisms that allow agents to retrieve structured data, interact with external services, or execute predefined computational tasks. Some agents access relational databases, while others retrieve information from vector stores, knowledge graphs, or real-time data streams. Access control settings regulate model instantiation and tool usage, ensuring agents execute only authorized functions. In an embodiment, authorization may be inherited from the user requesting the creation of the agent framework, or may be specified and associated with a an approval workflow to ensure that approvers are given the opportunity to approve the access and functionality of a particular agent. Function execution can occur synchronously, asynchronously, or as part of a distributed pipeline.

In accordance with an embodiment, agent creation module 304 establishes communication protocols that define how agents exchange information within the framework. Some agents communicate directly through message-passing protocols, while others interact via shared memory, event-driven architectures, or centralized task queues. Agent creation module 304 configures message formats, data serialization methods, and error-handling mechanisms to support structured communication. Coordination logic determines whether agents operate autonomously, require approval for certain actions, or escalate decisions to higher-level processes.

In accordance with an embodiment, agent creation module 304 deploys agents in execution environments that align with system architecture constraints. Some agents run in local processing environments, while others execute within containerized infrastructures, serverless architectures, or distributed computing frameworks. The module applies resource allocation policies that manage memory usage, computational load, and execution priorities. Some agents operate continuously, while others execute on demand, based on external triggers or scheduled tasks. Agent creation module 304 configures logging and monitoring mechanisms that track agent activity, log execution metrics, and detect performance anomalies.

In accordance with an embodiment, agent configuration module 306 applies settings that define operational parameters, execution conditions, and decision-making constraints for agents within agent framework management system 300. Agent configuration module 306 assigns parameter values that regulate computational resources, allowable actions, and model-specific tuning factors. Some configuration settings define execution frequency, while others determine interaction protocols or establish hierarchical relationships between agents.

In accordance with an embodiment, agent configuration module 306 assigns roles that determine how agents interact within a structured framework. Some roles require direct processing of input data, while others focus on orchestrating multi-agent workflows. Agent configuration module 306 sets operational conditions that determine whether agents execute tasks continuously, respond to external triggers, or process scheduled workloads. Configuration settings define conditions under which agents escalate decisions, defer processing, or modify execution logic based on real-time system feedback.

In accordance with an embodiment, agent configuration module 306 selects models and adjusts hyperparameters that influence agent decision-making. Some configurations define threshold values for model confidence, while others regulate computational constraints such as batch size, learning rate, or decision latency. Agent configuration module 306 assigns specific models to agents based on task complexity, available resources, or operational constraints. Some agents process structured data using rule-based logic, while others apply deep learning models that require tuning to maintain inference accuracy. Agent configuration module 306 reconfigures agents under certain circumstances. For example, an agent may be configured to use a computationally expensive LLM, but agent configuration module 306 may reconfigure the agent to use a model that is less computationally expensive when one becomes available or a triggering event occurs. For example, if a less computationally expensive model achieves a threshold accuracy metric or a resource constraint metric has been breached, then agent configuration module 306 may automatically swap the computationally expensive LLM for a the less computationally expensive model in the configuration without human approval or intervention.

In accordance with an embodiment, agent configuration module 306 integrates tool access and function execution settings that determine which external resources agents utilize. Some configurations allow access to API endpoints, databases, or computational functions, while others restrict agent interactions to predefined data sources. Execution parameters define whether agents perform direct function calls, retrieve preprocessed data, or operate within a managed pipeline. Security and permission settings control whether agents execute system-level operations, enforce read-only access, or require validation before performing actions.

In accordance with an embodiment, agent configuration module 306 defines communication protocols that regulate message formats, serialization methods, and synchronization mechanisms. Some configurations specify direct peer-to-peer messaging, while others establish centralized task queues or event-driven communication workflows. Coordination logic determines whether agents operate independently, share state information, or synchronize execution across multiple processing nodes. Error-handling configurations define fallback strategies when communication failures occur, ensuring task continuity and system stability.

In accordance with an embodiment, agent configuration module 306 applies deployment settings that define execution environments, runtime constraints, and monitoring parameters. Some configurations specify whether agents operate in containerized environments, serverless infrastructures, or dedicated compute clusters. Resource allocation settings regulate memory consumption, CPU utilization, and execution priority levels. Logging and diagnostic mechanisms track agent performance, record execution history, and generate reports for analysis. Configuration updates apply dynamically or require manual validation before modification, depending on system requirements.

In accordance with an embodiment, agent monitoring module 308 tracks agent activity, evaluates performance metrics, and detects deviations from expected behavior within agent framework management system 300. Agent monitoring module 308 collects execution logs, monitors resource utilization, and records system interactions to support real-time diagnostics and long-term performance analysis. Some monitoring processes focus on identifying operational inefficiencies, while others track communication failures, processing bottlenecks, or unexpected behavior that requires intervention.

In accordance with an embodiment, agent monitoring module 308 records execution parameters that provide insight into agent behavior over time. Logging mechanisms capture task completion rates, error occurrences, and response times, supporting assessment of whether agents operate within expected thresholds. Some logs track individual actions performed by agents, while others aggregate performance metrics across multiple executions to identify trends or systemic inefficiencies. Log retention policies define storage duration, retrieval mechanisms, and archival processes for historical analysis.

In accordance with an embodiment, agent monitoring module 308 evaluates resource consumption to ensure agents operate within predefined computational constraints. Some monitoring routines measure CPU and memory usage, while others track network bandwidth consumption or disk input/output activity. Monitoring processes detect anomalies such as excessive resource utilization, task starvation, or inefficient allocation of processing power. Some configurations enforce execution limits when predefined thresholds are exceeded, while others trigger alerts or dynamically adjust resource allocation policies.

In accordance with an embodiment, agent monitoring module 308 tracks communication and data exchange between agents to ensure adherence to defined protocols. Some monitoring processes validate message integrity, while others track delays in inter-agent communication or detect message loss. Synchronization monitoring assesses whether agents operate within expected coordination parameters, ensuring message sequencing and data dependencies align with operational requirements. Error detection mechanisms log failed transmissions, track retry attempts, and apply escalation protocols when persistent failures occur.

In accordance with an embodiment, agent monitoring module 308 applies behavior analysis techniques to detect deviations from expected execution patterns. Some processes compare observed behavior with predefined execution models, while others apply statistical methods to identify patterns indicating degraded performance or performance increases. Some monitoring routines focus on task accuracy, ensuring output consistency over time, while others detect drift in decision-making processes that may require recalibration. Some threshold-based triggers identify conditions that require intervention, such as prolonged execution times, repeated task failures, or degraded accuracy. Other threshold-based triggers identify when training thresholds have been met, such as when a model in training has achieved an acceptable accuracy threshold, indicating that the model in training is sufficiently accurate to perform a task without the assistance of a more computationally expensive model.

In accordance with an embodiment, agent monitoring module 308 applies alerting mechanisms that notify system operators or automated remediation or configuration processes when events occur. Some alerts provide real-time notifications through logging systems, while others trigger automated actions such as reconfiguring agents, restarting agents, adjusting execution parameters, or reallocating resources. Monitoring configurations define alert sensitivity, escalation procedures, and remediation strategies based on severity levels. Some notifications require manual intervention, while others integrate with automated recovery workflows to maintain system stability.

In accordance with an embodiment, tool management module 310 identifies, catalogs, and regulates access to tools 356 within agent framework 350. Tool management module 310 defines which tools are available for agents to use, manages tool registration, and enforces access control policies. Tools 356 comprise functionalities that agents utilize to perform tasks beyond the model with which they are associated. Some tools provide computational capabilities such as calculators or data transformation functions, while others retrieve or manipulate information from proprietary databases, external APIs, or file systems.

In accordance with an embodiment, tool management module 310 catalogs tools 356 by assigning metadata that describes functionality, input requirements, output formats, and execution constraints. Some tools support general-purpose operations such as mathematical computation, date and time processing, and unit conversion, while others provide domain-specific functions such as financial analysis, legal document parsing, or medical image processing. Tool management module 310 maintains an index of registered tools that agents reference when selecting resources to execute assigned tasks.

In accordance with an embodiment, tool management module 310 configures access permissions that regulate which agents can invoke specific tools. Some tools require unrestricted access, while others enforce security policies that limit execution to authorized agents based on role, task context, or hierarchical permissions. Authentication and authorization mechanisms validate agent credentials before granting tool access. Some configurations apply logging mechanisms that record tool usage, tracking which agents invoked tools, execution timestamps, and generated outputs for audit and compliance purposes.

In accordance with an embodiment, tool management module 310 manages tool invocation methods that define how agents interact with tools 356. Some tools execute locally within agent environments, while others require remote execution through API requests, cloud-based processing, or containerized services. Execution settings define input validation rules, output serialization formats, and error-handling procedures to ensure consistency across different tool interactions. Some configurations allow synchronous execution where agents wait for tool responses, while others support asynchronous execution where agents proceed with other tasks while waiting for tool results.

In accordance with an embodiment, tool management module 310 applies version control and update management to ensure tools remain functional and compatible with agent framework 350. Some tools undergo periodic updates that improve functionality, optimize performance, or introduce new capabilities. Versioning mechanisms track modifications, allowing agents to reference specific tool versions when execution stability requires consistency. Some update policies enforce immediate propagation of tool modifications, while others require validation before deployment to prevent disruptions in agent workflows.

In accordance with an embodiment, tool management module 310 integrates monitoring mechanisms that track tool availability, execution success rates, and failure conditions. Some tools require continuous availability for real-time processing, while others function in an on-demand capacity. Monitoring processes detect tool failures, execution timeouts, or degraded performance that may require remediation. Some configurations apply automated fallback strategies that redirect agent requests to alternative tools when primary tools experience downtime or resource limitations.

In accordance with an embodiment, tool management module 310 supports tool discovery mechanisms that allow agents to identify and request new tools dynamically. Some agent configurations define static tool assignments, while others allow agents to query tool management module 310 for available options based on task requirements. Tool recommendation algorithms suggest relevant tools based on agent task history, execution context, or predefined usage patterns. Some discovery processes apply ranking mechanisms that prioritize frequently used tools or those with optimal performance for specific task types.

In accordance with an embodiment, model management module 312 manages models available for use by agents within agent framework 350. Model management module 312 catalogs, configures, updates, and monitors models, ensuring compatibility with agent tasks and system requirements. Models managed by model management module 312 comprise large language models, mathematical models, statistical models, time-series forecasting models, physics-based simulation models, reinforcement learning models, and rule-based decision systems. Some models process natural language, while others generate predictions, optimize workflows, or perform specialized computations.

In accordance with an embodiment, model management module 312 catalogs models by maintaining metadata that describes model type, input requirements, output structures, and computational constraints. Some models operate as standalone inference engines, while others integrate into agent workflows as part of multi-model pipelines. Cataloging processes define model versioning, tracking updates and modifications to ensure agents reference appropriate model instances based on system requirements. Some configurations enforce backward compatibility, allowing older models to remain available for agents that require specific parameter settings or training data constraints.

In accordance with an embodiment, model management module 312 configures models for execution by assigning runtime parameters that regulate model behavior. Some models require predefined input normalization, feature selection, or dimensionality reduction before inference, while others operate on raw input data. Configuration settings define inference thresholds, response formatting, and post-processing requirements. Some models apply probability-based outputs that require threshold adjustments, while others generate deterministic predictions based on structured rule sets or mathematical formulations.

In accordance with an embodiment, model management module 312 manages model access policies, defining which agents can use specific models based on role, task scope, or security constraints. Some models require unrestricted access, while others enforce permission-based usage that limits execution based on predefined policies. Authentication mechanisms validate agent credentials before granting model access, preventing unauthorized inference requests. Some configurations log model usage, tracking execution instances, input-output pairs, and performance metrics for monitoring and audit purposes.

In accordance with an embodiment, model management module 312 applies model deployment strategies that regulate where and how models execute. Some models run on local processing environments, while others require cloud-based infrastructure, containerized deployment, or distributed computing frameworks. Deployment settings define memory and processing requirements, allocating computational resources based on expected inference load. Some configurations apply dynamic scaling, adjusting resource allocation based on real-time demand to maintain response times and system stability.

In accordance with an embodiment, model management module 312 monitors model performance, tracking accuracy, latency, and resource utilization. Some models require periodic retraining to maintain performance, while others remain static based on predefined rule sets. Monitoring processes detect model drift, identifying deviations in prediction accuracy over time due to shifts in input data distributions. Some configurations apply automated retraining pipelines that refresh model weights using newly available data, while others enforce manual validation before updating deployed models.

In accordance with an embodiment, model management module 312 applies version control mechanisms that track model iterations and allow agents to reference specific versions as needed. Some configurations support rollback capabilities, enabling system operators to revert to previous model versions if updates introduce performance degradation. Model lifecycle management processes define deprecation timelines, ensuring outdated models are retired when performance falls below acceptable thresholds. Some configurations allow agents to select model versions dynamically based on task requirements, optimizing inference based on historical performance metrics.

In accordance with an embodiment, model management module 312 integrates fallback mechanisms that redirect agent model requests when primary models become unavailable or fail inference checks. Some fallback strategies involve automatically switching to lower-complexity models when computational resources are constrained, even if the lower-complexity model has not completed enough training to meet defined accuracy threshold metrics. Others route requests to alternative models trained on overlapping datasets. Failover processes define recovery actions when model failures occur, preventing disruptions in agent workflows by ensuring continued access to operational models.

In accordance with one or more embodiments, distillation module 320 is configured to perform advanced training on models such as LLMs and other machine learning models that may be used by or made available for sue by agents. Distillation module 320 includes DPO logic 322, data management logic 324, and reward management logic 326.

In accordance with one or more embodiments, direct preference optimization (DPO) logic 322 is configured to refine model performance by adjusting learned parameters based on preference signals rather than explicit reward modeling. DPO logic 322 applies structured optimization techniques that align model outputs with human or system-defined preferences, improving response quality, task-specific relevance, or contextual accuracy. Some optimization routines modify model behavior through gradient-based updates, while others apply reinforcement learning strategies that iteratively adjust model outputs based on preference feedback.

In accordance with one or more embodiments, DPO logic 322 processes preference data that defines optimal or suboptimal responses based on historical interactions, expert annotations, or structured ranking datasets. Some configurations use pairwise ranking methods that compare competing outputs, while others apply absolute scoring mechanisms that assign preference weights to generated results. DPO logic 322 integrates preference signals into model training by adjusting loss functions, introducing regularization constraints, or applying weighting mechanisms that prioritize responses aligned with preferred behaviors.

In accordance with one or more embodiments, DPO logic 322 applies optimization techniques that adjust model outputs without requiring reinforcement learning with explicit reward functions. Some methods perform fine-tuning using preference-annotated datasets, modifying weights to reinforce preferred outputs while reducing reliance on less favorable predictions. Some configurations incorporate contrastive learning, where models learn to distinguish high-preference outputs from suboptimal alternatives, refining decision boundaries based on comparative evaluation.

In accordance with one or more embodiments, DPO logic 322 evaluates optimization performance by measuring alignment between trained model outputs and defined preferences. Some evaluation techniques use agreement metrics that compare generated responses to human or system-labeled preference datasets, while others apply divergence calculations that quantify the difference between pre- and post-optimization outputs. Some configurations introduce iterative refinement cycles where preference-annotated data continuously updates model parameters, ensuring adaptation to evolving user or system preferences.

In accordance with one or more embodiments, DPO logic 322 integrates into model deployment pipelines to maintain preference alignment after initial training. Some implementations apply ongoing preference-based fine-tuning to counteract distribution drift, ensuring models continue to prioritize high-relevance outputs. Some configurations support hybrid optimization strategies, combining direct preference signals with traditional loss-based training objectives to balance generalization with preference-specific refinements.

In accordance with one or more embodiments, data management logic 324 is configured to collect, store, preprocess, and manage training data, including synthetic preference data, for use in training models with DPO logic 322. Data management logic 324 organizes preference datasets that represent ranked choices, scoring distributions, or labeled comparisons, ensuring that models learn from consistent and well-defined preference patterns. Some datasets comprise generated preference rankings based on domain-specific heuristics, while others apply probabilistic modeling techniques to simulate user preferences.

In accordance with one or more embodiments, data management logic 324 applies data ingestion processes that integrate preference datasets from synthetic preference data generation pipelines. Some ingestion routines process batch-generated preference rankings, while others handle real-time synthetic preference updates based on evolving model training requirements. Schema enforcement mechanisms ensure that preference data adheres to predefined formats, maintaining consistency across different training cycles. Some configurations apply data normalization techniques that scale preference values within defined ranges, ensuring comparability across different ranking structures.

In accordance with one or more embodiments, data management logic 324 applies preprocessing techniques that format preference data for efficient model optimization. Some preprocessing routines transform raw preference scores into feature-encoded representations that align with model input requirements. Some configurations apply categorical encoding for ranked preferences, while others normalize ordinal data to maintain consistency across preference categories. Some preprocessing workflows filter low-confidence synthetic samples, ensuring that training data retains high fidelity to expected preference distributions.

In accordance with one or more embodiments, data management logic 324 applies storage and retrieval mechanisms that allow efficient access to preference datasets for iterative training cycles. Some implementations store preference data in indexed relational databases, while others apply key-value storage for rapid access to frequently queried ranking distributions. Partitioning strategies organize preference data based on model type, task specificity, or preference source, ensuring that training workflows use the most relevant preference information. Some configurations apply caching mechanisms that prioritize access to recently generated or frequently used preference rankings.

In accordance with one or more embodiments, data management logic 324 applies validation and consistency checks to ensure preference data quality before integration into training workflows. Some validation processes compare synthetic preference rankings against predefined preference rules, ensuring logical consistency within datasets. Some implementations apply statistical correlation analysis to verify alignment between synthetic preference distributions and expected ranking patterns. Some workflows detect inconsistencies in preference data by identifying preference reversals, missing ranking information, or deviations from expected scoring thresholds.

In accordance with one or more embodiments, data management logic 324 integrates feedback mechanisms that refine synthetic preference datasets based on training performance. Some feedback loops adjust synthetic preference generation parameters when model evaluations indicate divergence from expected learning outcomes. Some implementations dynamically weight preference rankings based on model accuracy trends, prioritizing high-impact training samples. Some configurations apply versioning policies that track modifications to preference datasets, ensuring reproducibility across multiple optimization cycles.

In accordance with one or more embodiments, reward management logic 326 is configured to generate, store, and apply reward signals used in training models with DPO logic 322. Reward management logic 326 processes preference data, assigns numerical values to learning outcomes, and adjusts model parameters based on reward-based feedback mechanisms. Some reward signals derive from synthetic preference rankings, while others incorporate manually labeled preference data or system-generated evaluations.

In accordance with one or more embodiments, reward management logic 326 applies ranking-based scoring methods to evaluate model outputs against preference data. Some scoring functions assign relative rankings by comparing multiple model-generated responses to determine the most aligned output. Some implementations apply absolute scoring techniques that evaluate individual responses based on predefined criteria. Some reward functions incorporate multi-factor evaluations, combining accuracy, fluency, and contextual relevance into weighted scoring systems.

In accordance with one or more embodiments, reward management logic 326 integrates adaptive reward scaling techniques that adjust reward distributions based on task complexity and model performance trends. Some implementations apply dynamic scaling, where reward values shift in response to evolving optimization targets. Some configurations apply reward normalization, ensuring that training stability is maintained across different preference datasets. Some reward structures use confidence-based adjustments, assigning higher reward values to outputs that align with high-certainty preference signals while reducing rewards for ambiguous or low-confidence predictions.

In accordance with one or more embodiments, reward management logic 326 applies reinforcement-based optimization mechanisms that refine model behavior using reward-weighted learning objectives. Some reward structures update model parameters through gradient-based optimization, while others apply policy-based learning techniques that adjust decision boundaries based on cumulative reward trends. Some implementations integrate reward shaping techniques that provide incremental reinforcement, ensuring models converge toward high-preference outputs without overfitting to specific training conditions.

In accordance with one or more embodiments, reward management logic 326 manages reward attribution strategies that determine how reward values propagate across training iterations. Some attribution mechanisms apply immediate reinforcement, where model updates occur after each evaluated prediction. Some configurations implement delayed reward aggregation, where cumulative reward signals influence model adjustments over extended training cycles. Some implementations distribute reward values proportionally across multi-step decision processes, ensuring that intermediate actions contribute to final preference-aligned outcomes.

In accordance with one or more embodiments, reward management logic 326 applies evaluation mechanisms that track reward consistency and alignment with expected model improvements. Some evaluation processes compare reward distributions across different training runs to detect variability in optimization trends. Some monitoring configurations detect reward sparsity, ensuring that models receive consistent reinforcement signals throughout training. Some implementations apply feedback loops that recalibrate reward values when training divergence is detected, maintaining alignment between preference data and model adaptation processes.

In accordance with one or more embodiments, reward management logic 326 enforces security and integrity controls that prevent reward manipulation and ensure unbiased preference-based training. Some implementations validate reward assignments by cross-referencing multiple scoring sources before applying updates. Some configurations enforce bounded reward ranges, preventing extreme values from distorting optimization objectives. Some implementations apply audit mechanisms that log reward assignments, ensuring traceability and compliance with system-defined training protocols.

In accordance with one or more embodiments, database 330 is configured to store, organize, and provide access to data used by agent framework 350, including models, preference data, validation records, and system configurations. Database 330 comprises one or more storage units that maintain structured or semi-structured data, supporting efficient querying, retrieval, and modification. Some implementations of database 330 store preference data for training and optimization, while others maintain operational logs, agent execution records, or validation results.

In accordance with one or more embodiments, database 330 comprises multiple storage systems that may include relational databases, NoSQL databases, object stores, distributed file systems, or in-memory data structures. Some implementations use relational storage for structured datasets that require transactional consistency, while others apply key-value or document-based storage for scalable access to preference models, agent configurations, or interaction histories. Some configurations apply hybrid storage mechanisms, combining high-throughput access patterns with durability guarantees.

In accordance with one or more embodiments, database 330 is configured to store model-related information, including versioned model checkpoints, hyperparameter configurations, and optimization metadata. Some storage mechanisms maintain historical training data, allowing retrieval of past model states for evaluation or rollback. Some implementations track relationships between models, agents, and associated tools 356, ensuring that deployed configurations maintain compatibility across system components.

In accordance with one or more embodiments, database 330 stores preference data used in training models with DPO logic 322, synthetic preference data generation, and evaluation by reference system 340. Some configurations apply indexing mechanisms that optimize retrieval of ranked preference scores, historical feedback, or validation assessments. Some implementations segment stored preference data based on task type, model requirements, or contextual relevance, ensuring that retrieval processes align with optimization workflows.

In accordance with one or more embodiments, database 330 stores validation results generated by validation module 342 and validation LLM 344. Some records track ground truth verifications for deterministic outputs, while others store qualitative assessments of subjective responses. Some configurations apply metadata annotations that document validation reasoning, score distributions, or identified inconsistencies, ensuring that reference system 340 maintains traceability of evaluation results. Some implementations allow adaptive storage policies where high-confidence validation records persist longer than low-confidence assessments.

In accordance with one or more embodiments, database 330 manages system configurations that define agent parameters, tool availability, access permissions, and resource allocation settings. Some implementations enforce schema validation to ensure configuration integrity, while others apply version control that tracks modifications over time. Some configurations apply access control policies that restrict modification of critical system parameters, ensuring that unauthorized changes do not impact operational stability.

In accordance with one or more embodiments, database 330 is deployed in one or more computing environments, including on-premises data centers, cloud-based storage infrastructures, or hybrid deployments that balance local and remote access. Some implementations apply replication strategies that ensure fault tolerance and high availability, while others optimize for low-latency access in real-time processing scenarios. Some database configurations integrate encryption and secure access mechanisms to protect sensitive stored data, ensuring compliance with system security policies.

In accordance with one or more embodiments, reference system 340 is configured to evaluate the accuracy and quality of outputs generated by models within agent framework 350. Reference system 340 applies validation techniques that assess responses based on objective correctness, contextual alignment, and qualitative relevance. Some evaluations produce numerical accuracy scores, while others generate metadata that explains validation results. Reference system 340 comprises validation module 342 and validation LLM 344, each performing distinct roles in output assessment.

In accordance with one or more embodiments, validation module 342 is configured to evaluate generated outputs against known ground truth data. Some validation processes apply deterministic verification, where generated responses are compared against predefined answers, mathematical calculations, or established factual references. Some implementations define ground truth datasets using authoritative sources, structured databases, or manually curated reference corpora. Some validation workflows integrate rule-based logic, applying constraint checks that verify consistency, logical coherence, or mathematical correctness.

In accordance with one or more embodiments, validation module 342 applies domain-specific validation mechanisms that assess outputs based on task-specific correctness criteria. Some validation routines evaluate arithmetic and algebraic computations by comparing numerical outputs against precomputed solutions. Some workflows verify factual statements by cross-referencing structured knowledge bases, scientific datasets, or legally binding documentation. Some validation techniques apply symbolic reasoning, where generated logic-based responses undergo structural verification against formalized proof systems or programmatic evaluation methods.

In accordance with one or more embodiments, validation module 342 applies confidence scoring techniques that quantify the reliability of correctness assessments. Some implementations define certainty thresholds that distinguish between fully verified, partially verified, and unverifiable responses. Some scoring methods apply probabilistic modeling, where validation confidence depends on input ambiguity, data sparsity, or systemic uncertainty. Some validation workflows generate structured metadata that explains scoring results, identifying potential inconsistencies or ambiguities in generated responses.

In accordance with one or more embodiments, validation LLM 344 is configured to evaluate subjective or non-deterministic model outputs that lack explicit ground truth references. Some validation tasks assess text-based outputs, such as email drafts, summarizations, or recommendations, based on coherence, clarity, and contextual appropriateness. Some workflows apply ranking-based evaluation, where multiple generated outputs undergo comparative assessment based on qualitative criteria. Some implementations integrate human-aligned preference models, refining validation criteria based on curated datasets or expert-labeled examples.

In accordance with one or more embodiments, validation LLM 344 applies structured reasoning to determine the quality of generated responses. Some workflows evaluate textual responses for linguistic fluency, logical progression, and adherence to formatting conventions. Some validation methods assess alignment with inferred user intent, identifying whether generated outputs fulfill task-specific objectives. Some scoring frameworks apply weighted evaluation metrics that balance readability, factual soundness, and stylistic appropriateness.

In accordance with one or more embodiments, validation LLM 344 generates metadata that provides explanatory context for assigned evaluation scores. Some validation processes highlight grammatical errors, inconsistencies, or logical gaps in generated responses. Some workflows generate corrective feedback, identifying areas where a model's response could be improved based on inferred best practices. Some validation routines apply adaptive scoring mechanisms, where evaluation thresholds adjust dynamically based on content complexity, domain specificity, or inferred response expectations.

In accordance with one or more embodiments, reference system 340 integrates validation module 342 and validation LLM 344 to provide comprehensive output assessment across objective and subjective tasks. Some validation workflows apply hybrid validation methods, where deterministic correctness checks complement qualitative evaluations. Some implementations define arbitration mechanisms that reconcile discrepancies between ground truth verification and subjective scoring models. Some validation pipelines generate aggregated evaluation reports, combining numerical accuracy scores, contextual assessments, and metadata-driven feedback to refine model performance.

In accordance with one or more embodiments, agent framework 350 defines a structured system for managing the lifecycle, execution, and coordination of agents within an operational environment. Agent framework 350 comprises multiple components, including agent creation module 304, agent configuration module 306, agent monitoring module 308, tool management module 310, model management module 312, and distillation module 320. Some implementations of agent framework 350 operate as centralized systems where agents execute tasks under a unified control structure, while others apply decentralized architectures that allow agents to operate independently or in collaborative workflows. Some frameworks define explicit hierarchies where specialized agents coordinate execution, while others apply peer-based interaction models that allow distributed decision-making.

In accordance with one or more embodiments, agent framework 350 manages agents that perform various roles, including data processing, information retrieval, task orchestration, decision-making, and content generation. Some agents operate as standalone entities performing isolated functions, while others interact dynamically with models, tools 356, and external systems to accomplish complex workflows. Some implementations configure agents to execute in real time, responding to immediate input conditions, while others operate asynchronously, processing data in batches or based on scheduled triggers. Agent framework 350 regulates how agents interact, defining communication protocols, execution constraints, and dependencies on external resources.

In accordance with one or more embodiments, generator agent 352 is configured to produce structured or unstructured output based on task-specific requirements. Some generator agents apply large language models to generate textual content, while others use statistical or rule-based methods to create domain-specific outputs. Some implementations of generator agent 352 apply retrieval-augmented generation, incorporating external knowledge sources to refine generated responses. Some configurations integrate direct preference optimization using DPO logic 322, ensuring that generated content aligns with predefined user or system preferences.

For example, a generator agent may produce marketing email copy for customer engagement, incorporating personalization elements, promotional language, and structured formatting guidelines. Some implementations generate subject lines optimized for engagement, while others create full email bodies tailored to user segments. Some configurations integrate real-time market trend data to adjust messaging strategies dynamically. Some generator agents evaluate historical campaign performance to refine output based on prior success metrics, ensuring consistency with brand voice and engagement patterns.

A different generator agent may create technical documentation in an embodiment, including structured reports, user manuals, or automated summaries of system logs. Some implementations extract key insights from organizational data stored in a database, formatting output for readability and comprehension. Some configurations integrate domain-specific terminology databases, ensuring consistency across generated materials. Some generator agents operate within compliance-driven environments, applying validation mechanisms through reference system 340 to ensure technical accuracy and alignment with regulatory requirements.

A generator agent may also produce image assets based on textual descriptions in an embodiment, applying generative models trained on multimodal datasets. Some implementations create marketing visuals, while others generate diagrams or illustrations for educational materials. Some configurations integrate style adaptation techniques, ensuring generated images align with branding guidelines or predefined aesthetic constraints. Some generator agents adjust output dynamically based on content requirements, optimizing resolution, aspect ratio, or design complexity.

In accordance with one or more embodiments, agent framework 350 comprises additional agent types that perform specialized functions beyond content generation. Some retrieval agents locate relevant documents, structured data, or real-time information sources based on user queries or system needs. Some decision-making agents apply rule-based logic, machine learning models, or probabilistic frameworks to support automated decision workflows. Some coordination agents manage task execution across multiple agents, ensuring dependencies are resolved, and output is processed in the correct sequence. Some validation agents evaluate generated content against predefined accuracy metrics, applying assessments using validation module 342 or validation LLM 344.

In accordance with one or more embodiments, critique agent 354 is configured to provide a critique of output created by generation modules. For example, critique agent 354 may determine that a particular marketing copy output created by generator agent 352 does not meet certain criteria, such as criteria input by a user into the framework related to the use of professional tone in the copy. Critique agent 354 is associated with a machine learning model, but leverages information from reference system 340 to determine the accuracy of the generated response. Critique agent 354 uses its associated model to generate a critique based in part on the accuracy of the output by performing an analysis of the input into the generation agent and the analysis from the reference system 340. Using its associated model, the critique agent generates a critique that indicates one or more accuracies or deficiencies in the response, sometimes accompanied by explanatory information.

In accordance with one or more embodiments, critique agent 354 is configured to evaluate responses by determining their correctness, quality, or relevance based on predefined criteria. Reference system 340 applies validation mechanisms to classify responses as good or bad and generates metadata that explains why a response meets or fails to meet expected standards. Some classifications rely on deterministic correctness checks using validation module 342, while others apply qualitative assessment using validation LLM 344.

In accordance with one or more embodiments, critique agent 354 generates metadata that describes the quality of the response. Some explanations provide reasoning based on linguistic patterns, such as clarity, grammar, and readability. Some explanations assess logical flow, identifying inconsistencies, contradictions, or missing context. Some implementations generate structured feedback, outlining specific areas of improvement for refinement in future iterations. Some workflows apply error detection models that highlight inaccuracies, ambiguities, or non-optimal phrasing.

In accordance with one or more embodiments, critique agent 354 applies hybrid validation techniques that combine correctness verification with qualitative judgment. Some evaluation pipelines integrate outputs from validation module 342 and validation LLM 344, ensuring that assessments capture both objective and subjective quality factors. Some implementations assign weighted scores, balancing deterministic accuracy with human-aligned preference scoring.

In accordance with one or more embodiments, critique agent 354 applies iterative refinement cycles that adjust response evaluation criteria based on observed performance trends. Some implementations recalibrate scoring models based on user feedback, refining assessment logic over time. Some validation methods incorporate reinforcement learning mechanisms that adapt validation thresholds dynamically. Some configurations integrate domain-specific validation protocols, ensuring evaluation criteria reflect task-specific requirements while maintaining general applicability across different response types.

In accordance with one or more embodiments, critique agent 354 itself is subject to critique. For example, a separate critique agent may be configured to provide critiques of other critique agents. The terms generation agent and critique agent are used herein to assist with understanding, but a critique agent is a type of generation agent; it just happens to generate critique output. Agent framework 350 may include many other agents of varying types that are associated with varying functionality.

In accordance with one or more embodiments, tools 356 comprise functionalities that agents within agent framework 350 use to perform specific tasks beyond the capabilities of the models with which they are associated. Tools 356 provide access to computational resources, data retrieval systems, external APIs, and processing functions that extend agent functionality. Some tools execute mathematical calculations, data transformations, or unit conversions, while others interact with structured databases, proprietary knowledge repositories, or real-time information sources.

In accordance with one or more embodiments, tools 356 are identified, cataloged, and managed by tool management module 310. Some tools are implemented as standalone functions that agents invoke through direct execution, while others operate as remote services accessed through API calls or distributed processing frameworks. Some tools integrate authentication and permission controls, ensuring that agents access only authorized functionalities. Some implementations define execution constraints that regulate resource usage, execution time, or concurrency limits.

In accordance with one or more embodiments, tools 356 support domain-specific operations that enhance agent task execution. Some tools apply search and retrieval mechanisms that extract relevant documents, structured data, or contextual references from indexed repositories. Some tools execute financial modeling, statistical analysis, or optimization algorithms that assist in decision-making processes. Some implementations provide natural language processing utilities that refine text generation, improve grammatical correctness, or translate content between languages.

In accordance with one or more embodiments, tools 356 integrate with external systems to provide real-time data access and interactive processing capabilities. Some tools connect to market data feeds, weather services, or regulatory databases, ensuring that agents incorporate the latest available information into generated outputs. Some implementations access proprietary enterprise systems, retrieving business intelligence reports, transactional data, or operational insights. Some configurations support multi-step tool execution, where agents invoke sequences of tools to accomplish complex workflows.

In accordance with one or more embodiments, tools 356 support function execution that enhances agent adaptability. Some tools allow agents to call external APIs that trigger automated workflows, update system records, or generate reports. Some implementations apply computational modeling tools that simulate scenarios, predict outcomes, or analyze risk factors. Some tools interact with document processing engines, enabling agents to extract structured information from PDFs, spreadsheets, or scanned images.

In accordance with one or more embodiments, tools 356 apply structured input-output handling mechanisms that standardize interactions between agents and external functionalities. Some configurations define data validation protocols that ensure input formats conform to expected structures before tool execution. Some implementations apply serialization techniques that maintain consistency across tool-generated outputs. Some tools return results in predefined formats, allowing agents to process responses efficiently without additional transformation steps.

In accordance with one or more embodiments, tools 356 integrate monitoring and logging mechanisms that track usage patterns, execution success rates, and failure conditions. Some monitoring configurations detect tool availability issues, triggering fallback mechanisms that redirect agent requests to alternative tools. Some implementations generate execution logs that document tool invocation sequences, input parameters, and generated outputs for diagnostic or auditing purposes. Some tools support versioning, ensuring that agents reference stable tool implementations while allowing for controlled updates or feature expansions.

Additional embodiments and/or examples relating to computer networks are described below in Section 7 titled “Computer Networks and Cloud Networks.”

Information describing the components shown in FIG. 3 may be implemented across any of components within the agent framework management system 300. However, this information is described as residing within the database 330 for purposes of clarity and explanation.

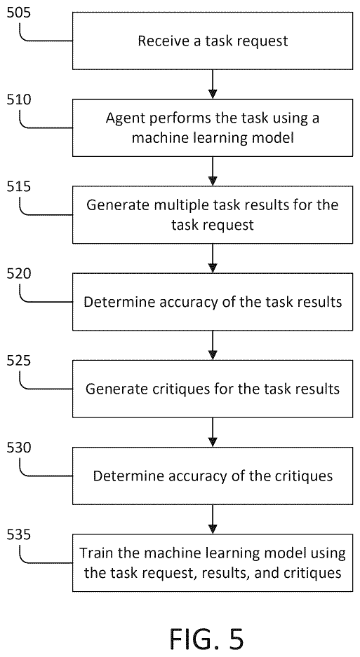

In one or more embodiments, a module refers to hardware and/or software configured to perform operations described herein for that module. Examples of operations for agent framework management system 300 are described below with reference to FIG. 5.

In an embodiment, agent framework management system 300 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

In one or more embodiments, an interface (hardware and/or software configured to facilitate communications between a user and agent framework management system 300) may be used. The interface renders user interface elements and receives input via user interface elements. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms.

In an embodiment, different components of an interface are specified in different languages. The behavior of user interface elements is specified in a dynamic programming language, such as JavaScript. The content of user interface elements is specified in a markup language, such as hypertext markup language (HTML) or XML User Interface Language (XUL). The layout of user interface elements is specified in a style sheet language, such as Cascading Style Sheets (CSS). Alternatively, an interface is specified in one or more other languages, such as Java, C, or C++.

### Dataset Generation and Distillation

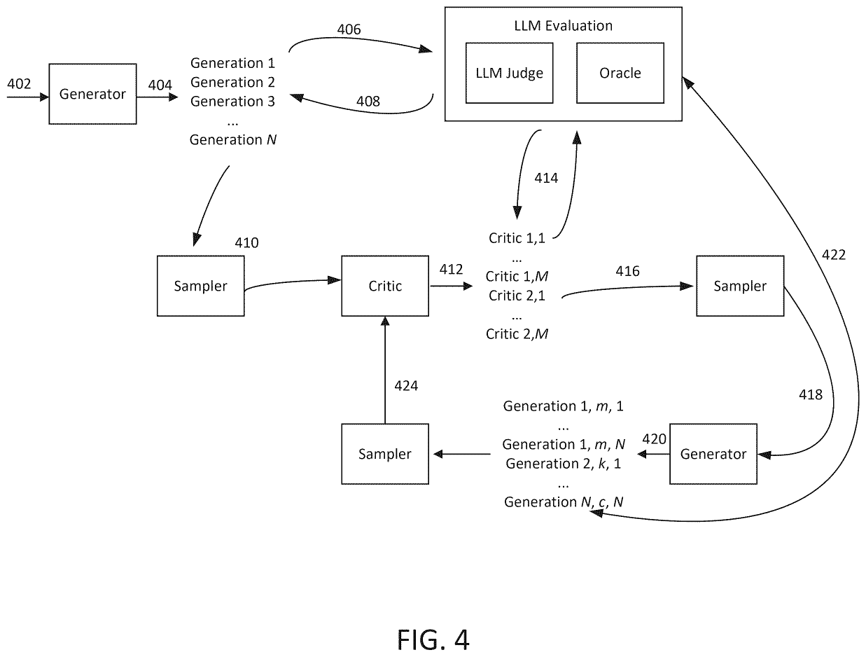

FIG. 4 illustrates an example set of operations for training dataset generation and distillation in accordance with one or more embodiments. One or more operations illustrated in FIG. 4 may be modified, rearranged, or omitted altogether. Accordingly, the particular sequence of operations illustrated in FIG. 4 should not be construed as limiting the scope of one or more embodiments.

In accordance with one or more embodiments, an agent is trained using imitation learning through supervised fine-tuning (SFT) by learning from expert-provided demonstrations. Training data consists of input-output pairs where human-labeled responses guide the agent's behavior, allowing the model to generalize decision-making patterns based on observed examples. Some training workflows involve direct replication of expert actions, while others refine model responses by minimizing the difference between predicted outputs and demonstrated responses using loss functions. Feature preprocessing ensures that training data is structured for consistency, filtering ambiguous examples and normalizing variations in task execution. Some training strategies apply curriculum learning, where the agent first learns simple tasks before progressing to more complex scenarios, stabilizing convergence and improving generalization. Iterative validation assesses model performance, ensuring alignment between learned behaviors and expected outputs. Some training pipelines integrate reinforcement mechanisms, refining responses through additional preference data that prioritizes high-quality outputs. After fine-tuning, the agent is evaluated against validation datasets, comparing generated outputs to expert demonstrations to measure accuracy, consistency, and task adherence.

In accordance with one or more embodiments, a request is sent to the agent, specifying an input that the agent processes based on its configured role, model, and available tools (Operation 402). The request may contain structured or unstructured data, defining the task parameters, execution context, and any constraints that govern the agent's response. Some requests require direct computation, such as solving a mathematical expression or retrieving a specific data record, while others involve more complex reasoning, such as generating a summary of a document or drafting a response to a user query. Some requests include additional metadata that informs the agent of priority levels, response formatting requirements, or external resources needed for processing.

For example, a request may ask the agent to generate a marketing email promoting a new product launch. The request could specify details such as the target audience, key selling points, tone of voice, and call-to-action preferences. The agent processes the request by retrieving relevant brand messaging guidelines, applying a language model to generate persuasive and engaging copy, and structuring the email for readability. Some implementations apply optimization techniques to refine subject lines for higher engagement or integrate A/B testing parameters to compare different versions of the email.

In accordance with one or more embodiments, the agent with a generator persona or role (labeled “Generator”) processes the request by invoking its assigned model, applying decision logic, and leveraging tools as necessary to produce a response (Operation 404). Additional responses are generated, including Generation 1, Generation 2, Generation 3, . . . . Generation N.

In accordance with one or more embodiments, generations produced by an agent are sent to reference system 340 for evaluation (Operation 406). Reference system 340 assesses the quality, accuracy, and relevance of the generated output using validation module 342 (labeled “Oracle” on the diagram) and validation LLM 344 (labeled “LLM Judge”) on the diagram. Some generations undergo deterministic validation, where validation module 342 compares the output against established ground truth data, while others require subjective assessment, where validation LLM 344 evaluates coherence, style, or contextual appropriateness.

In accordance with one or more embodiments, validation module 342 processes generations that can be objectively verified, such as numerical calculations, structured data retrieval, or rule-based decision-making. Some validation workflows apply direct matching techniques, ensuring that the generated output aligns with predefined answers stored in authoritative databases. Some implementations use logical consistency checks, enforcing constraints that validate whether the output adheres to expected structural or mathematical rules.

In accordance with one or more embodiments, validation LLM 344 evaluates generations that lack definitive correctness criteria, such as natural language outputs, content summarization, or creative responses. Some validation processes apply ranking-based scoring, comparing multiple generated outputs to determine which best aligns with qualitative expectations. Some implementations apply reasoning frameworks, where the validation LLM 344 generates explanatory metadata that describes the strengths and weaknesses of the response. Some validation workflows integrate user-defined preference models, ensuring that generations meet stylistic or domain-specific requirements.

In accordance with one or more embodiments, reference system 340 generates structured evaluation reports that include accuracy scores, contextual feedback, and metadata describing why a generation is classified as good or bad (Operation 408). Some assessments return binary classifications, distinguishing between acceptable and unacceptable outputs, while others provide confidence-weighted scores that reflect degrees of correctness or alignment with preferred outcomes. Some implementations apply iterative refinement, where agents use validation feedback to improve future generations, optimizing responses over multiple iterations. Rewards may then be assigned to each generation based on the accuracy determination from the reference system.

In accordance with one or more embodiments, a sampler selects a set of generations with corresponding request details and reference system results, and passes them to an agent with a critic role or persona (Operation 410). The critic agent generates a set of critiques for the selected sample of generations (Operation 412). These critiques are labeled Critic 1,1 . . . . Critic 1,M and Critic 2,1 . . . . Critic S,M, indicating that for each generation, multiple critiques are generated. The purpose of generating multiple critiques for each generation in the sample is to determine which critiques are helpful and which critiques are unhelpful.

In accordance with one or more embodiments, reference system 340 is used to evaluate critiques in the same way that reference system was used to evaluate generations (Operation 414). However, the context is different as the role or persona of the agent in this case is that of a critic. This, reference system 340 determines whether or not the critique is helpful for training purposes. For example, a critique that is unhelpful may be assigned a low reward, even if the generation that is being critiqued is accurate. In an embodiment, the generation-critique combination is assigned a composite reward that takes into account the usefulness of both the generation and the critique.

In accordance with one or more embodiments, the system runs a direct preference optimization (DPO) training process using preference pairs of generations and associated critiques. The generator model and the critic model may both be trained in this way if desired. There is no limitation on which models may be trained in this way, regardless of agent role or persona. Preference pairs comprise two or more generated outputs ranked based on quality, correctness, or alignment with predefined objectives. Some preference pairs originate from validation module 342, which assigns rankings based on ground truth comparisons, while others derive from validation LLM 344, which evaluates responses based on qualitative or contextual criteria. Associated critiques provide additional context, such as metadata describing evaluation rationale, task-specific constraints, or historical user preferences that influence optimization.

In accordance with one or more embodiments, the system applies DPO logic 322 to adjust model parameters based on preference-ranked generations. Some training pipelines minimize divergence between the preferred and less preferred generations, reinforcing decision-making patterns that align with higher-ranked outputs. Some implementations use contrastive learning techniques, where models learn to distinguish high-quality generations from lower-ranked alternatives, refining response boundaries based on comparative evaluation. Some optimization processes apply weighting functions that emphasize preference consistency across multiple training iterations, preventing overfitting to isolated preference pairs.

In accordance with one or more embodiments, critiques are incorporated into training by influencing reward scaling, confidence thresholds, or input transformations that adjust the learning process. Some implementations use probabilistic modeling to refine preference distributions, ensuring that preference assignments generalize beyond individual training samples. Some training workflows apply dynamic sampling techniques, prioritizing high-impact preference pairs that drive the most significant improvements in model behavior. Some configurations integrate reinforcement-based adjustments, where updated preference rankings continuously refine model decision boundaries as new preference data becomes available.

In accordance with one or more embodiments, the system evaluates DPO training effectiveness by measuring improvements in generation quality across validation datasets. Some assessment workflows compare pre- and post-training model outputs against preference benchmarks, ensuring optimization stability. Some implementations apply statistical analysis to detect distributional shifts in learned preferences, ensuring that training does not introduce unintended biases. Some DPO pipelines integrate adaptive tuning strategies, where model adjustments scale dynamically based on observed preference alignment trends, maintaining consistency across evolving preference distributions.

In accordance with one or more embodiments, additional rounds of data generation, collection, and training may be performed (Operation 416). For example, a sample of the critiques may be passed back to the generator after training (Operation 418). The generator may then generate multiple generations for the request, taking into account the previous results generations and critiques (Operation 420).

In accordance with one or more embodiments, a majority voting mechanism is applied after multiple rounds of direct preference optimization (DPO) training to determine high-quality responses and facilitate further model refinement. The system generates multiple candidate responses for the same input across iterative training cycles and applies ranking mechanisms to evaluate preference consistency (Operation 420). Generations produced by an agent are sent to reference system 340 for evaluation (Operation 422). A sample of these generations may be sent to the critic for evaluation. (Operation 424). Some implementations aggregate preference rankings across multiple training iterations, while others apply voting-based selection criteria to identify the most frequently preferred responses. Some configurations generate multiple outputs from the trained model at different checkpoints, applying majority voting to determine which responses exhibit the highest stability in preference rankings.

In accordance with one or more embodiments, majority voting facilitates training by reinforcing stable preference patterns. Some implementations apply voting-based filtering to select the most frequently preferred responses as training targets for subsequent optimization rounds. Some configurations use preference aggregation to reduce noise in ranking data, ensuring that outlier preferences do not influence optimization trajectories. Some voting mechanisms assign weight distributions to preference-ranked responses, applying reinforcement-based adjustments that refine model parameters based on cumulative preference data.

In accordance with one or more embodiments, majority voting mechanisms guide reinforcement of high-quality responses in iterative DPO training. Some implementations integrate voting results into model training by applying preference-weighted loss functions that prioritize frequently preferred outputs. Some configurations adjust reward scaling based on majority-ranked preferences, reinforcing generation patterns that exhibit strong convergence across training rounds. Some voting-based optimization strategies identify shared structural or contextual features among consistently preferred responses, refining training objectives to improve generalization.

In accordance with one or more embodiments, majority voting mechanisms detect instability in preference rankings across iterative DPO training. Some implementations compare ranking distributions across multiple training checkpoints, identifying whether preference assignments fluctuate over training rounds. Some configurations apply divergence analysis to detect oscillations in model behavior, adjusting optimization parameters when majority consensus fails to emerge. Some voting-based assessment methods apply validation criteria to determine whether model refinement is required before further optimization, ensuring that preference rankings align with expected behavioral patterns.

In accordance with one or more embodiments, majority voting mechanisms integrate into preference optimization pipelines while maintaining flexibility in training outcomes. Some implementations apply voting-based selection only to deterministic or highly structured tasks, ensuring that generative diversity is preserved in open-ended responses. Some configurations apply adaptive voting thresholds that balance stability and variation, refining response aggregation criteria based on domain-specific requirements. Some voting-based training methods apply computational efficiency constraints, limiting voting-based refinement to high-impact preference ranking evaluations while preserving optimization scalability.

In accordance with one or more embodiments, additional accuracy benefits are gained by converging on a preferred answer after each turn. For example, rather than waiting for several rounds of DPO training to initiate majority voting, majority voting is initiated after each round of DPO training in an embodiment. Although conventional methods indicate that waiting for several rounds of training to implement majority voting helps to avoid overfitting, when performing majority voting after each round using the methods described herein, accuracy increases.

FIG. 5 illustrates an example set of operations for dataset generation and distillation in accordance with one or more embodiments. One or more operations illustrated in FIG. 5 may be modified, rearranged, or omitted altogether. Accordingly, the particular sequence of operations illustrated in FIG. 5 should not be construed as limiting the scope of one or more embodiments.

In accordance with one or more embodiments, the system receives a task request (Operation 505). The task request specifies an input that defines the parameters, objectives, or constraints for execution. Task requests may include structured data inputs, such as numerical values, database queries, or API calls, while others contain unstructured inputs, such as free-text queries or natural language prompts. In an embodiment, the system validates the task request upon receipt, checking for missing parameters, format inconsistencies, or ambiguous instructions before proceeding with execution. The system may apply preprocessing steps that standardize task inputs for downstream processing components.

In accordance with one or more embodiments, the agent performs the task using a machine learning model (Operation 510). The agent selects a model based on the task type, computational requirements, or predefined execution rules. Some implementations dynamically route task execution to different models based on performance benchmarks, availability, or accuracy requirements. The system may also apply preprocessing transformations before inference, ensuring that input data conforms to the expected format of the selected model. Some execution workflows invoke external tools 356, retrieving supplementary data or applying specialized processing functions before generating a response. In an embodiment, the system enforces execution constraints, regulating model inference time, resource allocation, or response length based on task complexity.

In accordance with one or more embodiments, the system generates multiple task results for the task request (Operation 515). The system generates multiple task results by sampling multiple outputs from the same model using varied decoding parameters, such as different temperature settings or top-k sampling strategies. In an embodiment, execution workflows generate variations of the same response, adjusting structure, phrasing, or contextual emphasis to increase response diversity. The system may integrate retrieval-augmented generation, where multiple task results incorporate external data sources, structured knowledge bases, or reference documents to refine accuracy and contextual relevance.

In accordance with one or more embodiments, the system determines the accuracy of the task results (Operation 520). In an embodiment, the system generates task results against ground truth data, applying deterministic validation methods through validation module 342. In an embodiment, accuracy assessments rely on reference system 340, where validation LLM 344 evaluates task results based on qualitative scoring criteria, ranking responses based on fluency, coherence, or domain-specific relevance. The system may apply statistical evaluation methods, measuring divergence between generated responses and expected outputs. Assessment workflows may integrate user feedback, refining accuracy determinations based on preference-aligned scoring mechanisms. In an embodiment, the system applies adaptive validation strategies, adjusting accuracy thresholds based on task complexity, available reference data, or real-time performance monitoring trends.

In an embodiment, the system generates multiple critiques for the task results (Operation 525). A subset of available task results may be used for purposes of critiquing, depending on whether or not the task result (or generation) is associated with a reward based on accuracy. In accordance with one or more embodiments, only a subset of generated outputs is selected for use in training based on preference ranking, evaluation criteria, or optimization constraints. The system may prioritize outputs that exhibit high alignment with preference rankings, while others incorporate low-ranked outputs to refine decision boundaries through contrastive learning. In an embodiment, training pipelines apply filtering mechanisms that exclude outputs with ambiguous rankings, ensuring that training data remains well-defined and consistent across iterations. In accordance with one or more embodiments, the system generates critiques by sampling multiple outputs from the same model using varied decoding parameters, such as different temperature settings or top-k sampling strategies.

In accordance with one or more embodiments, the lack of a reward may result in the selection of a particular output for training because it represents a negative learning signal. Optimization strategies may be used. For example, the system may apply contrastive learning techniques, where lower-ranked outputs reinforce distinctions between preferred and non-preferred responses. In an embodiment, the system incorporates outputs that fail validation as counterexamples, preventing the model from reinforcing incorrect or undesirable response patterns. Training workflows may also assign loss penalties to low-quality outputs, reducing the model's likelihood of generating low-quality outputs in future iterations.

In accordance with one or more embodiments, training selection processes balance positive and negative learning signals to optimize model performance. For example, dynamic weighting may be assigned to selected outputs, increasing the influence of high-confidence preference rankings while incorporating non-preferred responses at lower impact levels. Other optimization strategies may include adversarial filtering, selecting outputs that challenge the model's decision-making accuracy to refine optimization objectives. Human feedback loops may also be integrated, allowing user-defined selection criteria to override automated ranking mechanisms.

In accordance with one or more embodiments, selection mechanisms define thresholds that determine whether a generated output is used in training. Some implementations apply minimum confidence requirements, so that selected outputs exhibit a sufficiently high or low preference score before inclusion in optimization cycles. Some training workflows apply ranking-based selection, where only the top and bottom percentage of generated outputs influence parameter updates. Some implementations dynamically adjust selection criteria based on training progression, increasing the reliance on higher-quality outputs as optimization converges while maintaining exposure to negative learning signals where necessary.

In accordance with one or more embodiments, validation-based filtering mechanisms influence output selection for training. Some implementations incorporate outputs that receive validation feedback indicating factual inaccuracies, logical inconsistencies, or formatting deviations, ensuring that the model adjusts decision boundaries to correct recurring errors. Some selection processes prioritize outputs with clear validation results while excluding uncertain or borderline responses that may introduce noise into optimization workflows. Some implementations integrate reference system 340 to refine training selection, ensuring that selected outputs align with objective correctness evaluations from validation module 342 or subjective quality assessments from validation LLM 344.

In an embodiment, the system determines the accuracy of the critiques (Operation 530). In an embodiment, accuracy assessments rely on reference system 340, where validation LLM 344 evaluates critiques based on qualitative scoring criteria, ranking responses based on fluency, coherence, or domain-specific relevance.

In an embodiment, the system trains the machine learning model using a tuple comprising the task request, task results, and critiques (Operation 535). In an embodiment, the system uses DPO to perform training by adjusting the machine learning model's parameters based on preference-ranked outputs. Some training workflows construct preference pairs, where the system compares two or more generated responses and assigns relative rankings based on predefined criteria. Some implementations apply a contrastive loss function that increases the likelihood of generating higher-ranked responses while reducing the probability of producing lower-ranked alternatives. Some training pipelines incorporate preference-weighted gradient updates, ensuring that optimization aligns model behavior with human or system-defined preferences. Some implementations integrate reinforcement-style learning without explicit reward modeling, allowing the model to generalize across diverse preference signals without requiring a separate reward function. Some optimization strategies refine decision boundaries iteratively, updating the model across multiple training cycles to reinforce stable preference-aligned behaviors.

In an embodiment, the critic agent is associated with a different machine learning model than the generator agent. The system may also train the machine learning model associated with the critic agent using a combination of task requests, task results, and critiques.

In accordance with one or more embodiments, a critique accuracy indicator is generated for one or more critiques. For each critique, a corresponding critique is generated based at least in part on the critique accuracy indicator.

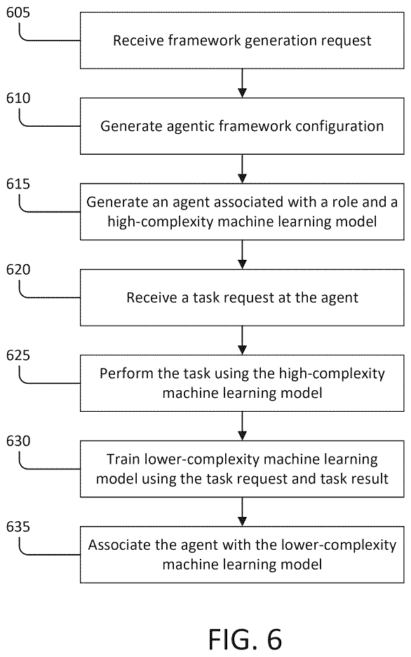

FIG. 6 illustrates an example set of operations for training a machine learning model in accordance with one or more embodiments. One or more operations illustrated in FIG. 6 may be modified, rearranged, or omitted altogether. Accordingly, the particular sequence of operations illustrated in FIG. 6 should not be construed as limiting the scope of one or more embodiments.

In accordance with one or more embodiments, the system receives a framework generation request (Operation 605). For example the request may specify the parameters needed to generate an agentic framework designed to automate the creation of marketing content. The request may define the number and type of agents, the complexity of the language models required, and the integration of external tools 356, such as customer engagement analytics, sentiment analysis, and SEO optimization tools. Agent framework management system extracts a clear definition of the requested process by interacting with the requestor using natural language processing and other mechanisms capable of parsing and interpreting the request. The system leverages organizational metadata, which includes user roles and permissions, data availability and access rights, and available tools and APIs.

The system may validate the request by verifying that the specified components are compatible, that required resources are available, and that model constraints align with the intended marketing objectives. Some framework generation requests specify guidelines for brand consistency, tone, and style, ensuring that agents generate outputs aligned with existing marketing strategies. Some implementations generate code-based configurations for agent orchestration frameworks such as CrewAI, AutoGen, or LlamaIndex, structuring the agent execution environment according to predefined specifications. The system may generate configuration files, API bindings, or execution scripts that instantiate the agentic framework dynamically.

In accordance with one or more embodiments, the system generates an agentic framework configuration (Operation 610). The system translates the requester's process and requirements description that may include logical process steps, objectives, and dependencies into an initial agentic framework draft that is structured as a directed graph. Each node in the directed graph represents a step in the process, and each edge defines interactions between these steps. The framework may represent a workflow, for example, which may include cycles that accommodate iterative or feedback-driven processes. Each step in the workflow represents an agent that utilizes an LLM, which can assume different roles. For example, a generator produces initial outputs or refinements for a given step; a critic reviews and provides actionable feedback; and a “tool user” leverages enterprise APIs and tools to complete tasks.

The system structures the framework by defining relationships between agents, assigning operational parameters, and specifying the decision-making hierarchy for content generation. The configuration may include a lead content-generation agent, which drafts marketing emails, a review agent that applies quality control measures, and a distribution agent that schedules and deploys content through various communication channels. The system may define execution workflows that determine how agents interact, whether sequentially for validation purposes or in parallel for efficiency. Some configurations integrate adaptive learning components, where agent performance metrics inform future refinements to the framework. Some implementations use CrewAI to define role-based agent interactions, where each agent is assigned a function within the framework based on predefined behaviors and constraints. The system may apply AutoGen to configure multi-agent collaboration strategies, specifying agent communication protocols and execution dependencies. Some configurations integrate LlamaIndex for knowledge retrieval, equipping agents with structured access to marketing databases, historical campaign data, or customer segmentation insights.

To ensure accuracy, the system not only adheres to the user's intent but also enforces logical and structural constraints that govern workflow execution. Additionally, it can identify gaps in tooling that prevent system from creating the workflow for the underlying process. If such gaps exist, the agent informs the user that the workflow cannot be fully generated and highlights the specific missing tools or functionalities. Once the initial workflow is generated, users can refine it through natural language interactions, dynamically modifying the structure as needed.

This iterative interaction results in a finalized workflow, that not only defines its structure but also captures key execution details for each step. The finalized workflow may define step-to-step interactions that are represented by input/output signatures and the nature of their dependencies. Tools and APIs may also be defined, indicating the tools/APIs to be used within the step and requirements governing the usage. Finally, LLM instructions and personas are used to define the prompts and behaviors of LLM-powered steps.

In accordance with one or more embodiments, the system generates an agent associated with a role and a high-complexity machine learning model (Operation 615). The system assigns the agent the role of a marketing content generator, configuring parameters that define tone, formatting preferences, and engagement strategies. The system selects a high-complexity language model capable of producing persuasive, brand-aligned email campaigns, adjusting hyperparameters such as temperature settings to balance creativity with factual consistency. The system may fine-tune the model using historical marketing data, customer response trends, and engagement analytics to align generated outputs with successful past campaigns. Some configurations equip the agent with the ability to access external datasets, such as competitor messaging patterns or trending industry keywords, to refine marketing strategies dynamically. Some implementations instantiate agents using CrewAI, assigning specific tools 356 and predefined models based on the role specifications. The system may configure AutoGen to manage prompt orchestration, ensuring that agent interactions follow an optimized query-response workflow for generating marketing content. Some configurations apply LlamaIndex to allow the agent to retrieve and incorporate contextual data, such as brand guidelines, customer segmentation details, and recent product launches, into generated outputs.

In accordance with one or more embodiments, the agent receives a task request (Operation 620). The task request specifies the details for a particular marketing email, including the product being promoted, the target audience, and any campaign-specific messaging constraints. The system may preprocess the request by verifying that all necessary details are provided, extracting relevant context from customer engagement history, and applying sentiment analysis to ensure alignment with audience expectations. Some task requests include additional requirements, such as A/B testing parameters, where the agent generates multiple variations of an email to determine the most effective version. The system may prioritize task execution based on urgency, ensuring that time-sensitive campaigns receive immediate processing while evergreen content follows a scheduled deployment workflow.

In accordance with one or more embodiments, the system performs the task using the high-complexity machine learning model (Operation 625). The system processes the task request by generating a marketing email that incorporates persuasive language, engaging subject lines, and a structured call-to-action. The system may reference previous high-performing campaigns, applying optimization techniques to improve conversion potential. Some implementations integrate real-time SEO analysis, sentiment scoring, and readability assessments, refining the draft before finalizing the output. The system may also apply audience segmentation strategies, tailoring variations of the email for different customer demographics. Some executions involve retrieval-augmented generation, where the model pulls in relevant customer feedback, past interactions, or industry-specific terminology to enhance the message's relevance.

In accordance with one or more embodiments, the system concurrently runs requests associated with the agent through a “shadow agent” with the same role or persona as the original agent, but the shadow agent is associated with a lower complexity machine learning model. The purpose of running the shadow agent in the background is to train the lower complexity machine learning model while using the higher complexity machine learning model to ensure that the system continues to work effectively for users.

In an embodiment, the system trains a lower-complexity machine learning model using the task request and the task result (Operation 630). In accordance with one or more embodiments, the system trains a lower-complexity machine learning model using outputs generated by a higher-complexity machine learning model. The system applies knowledge transfer techniques, where the lower-complexity model learns to approximate the decision-making patterns, response structures, or predictive capabilities of the higher-complexity model. Some training workflows use direct fine-tuning, where the lower-complexity model is optimized on a dataset comprising input-output pairs generated by the higher-complexity model. Some implementations apply distillation techniques, where the system extracts relevant information from the higher-complexity model's outputs, such as probability distributions, attention weights, or feature importance scores, to refine the lower-complexity model's learning process.

In accordance with one or more embodiments, the system applies model distillation by compressing the knowledge encoded in the higher-complexity model into a more computationally efficient representation. The system generates soft labels from the higher-complexity model, where probability distributions over multiple output classes provide additional training signals beyond standard one-hot encoded labels. Some distillation processes adjust temperature scaling in the higher-complexity model's output distributions to smooth probability values, allowing the lower-complexity model to generalize its learning across a wider range of training samples. Some implementations introduce contrastive learning, where the system trains the lower-complexity model to distinguish between high-confidence and low-confidence outputs from the higher-complexity model, reinforcing decision boundaries.

In accordance with one or more embodiments, the system applies reinforcement-based training, where the lower-complexity model refines its performance based on feedback derived from the higher-complexity model's evaluations. The system may generate multiple candidate responses from the lower-complexity model, comparing them against reference outputs from the higher-complexity model to determine alignment. Some training workflows assign reward values based on similarity scores, optimizing the lower-complexity model using direct preference optimization (DPO) techniques. Some implementations apply adaptive learning schedules, where the system dynamically adjusts training difficulty by introducing increasingly complex examples from the higher-complexity model over multiple iterations.

In accordance with one or more embodiments, the system applies retrieval-augmented fine-tuning, where the lower-complexity model is trained not only on raw outputs from the higher-complexity model but also on intermediate reasoning steps or auxiliary data sources referenced during inference. Some implementations use attention distillation, where the system extracts intermediate feature representations from the higher-complexity model and uses them as guidance signals during training. Some training workflows apply parameter pruning techniques, where the system identifies redundant components of the higher-complexity model's architecture and replicates only the most impactful layers in the lower-complexity model.

In accordance with one or more embodiments, the system validates the performance of the lower-complexity model against evaluation metrics that compare its outputs with those of the higher-complexity model. Some validation workflows measure task accuracy, fluency, or response coherence, applying scoring mechanisms that assess alignment with previously generated outputs. Some implementations introduce hybrid evaluation strategies, where the system applies both deterministic validation through reference system 340 and qualitative assessment using validation LLM 344. Some configurations refine the training process iteratively, where discrepancies between the lower-complexity and higher-complexity models inform targeted adjustments to model weights, hyperparameters, or training data selection.

In accordance with one or more embodiments, the techniques using DPO described in section 5 above may be used to train the lower-complexity machine learning model. For example, the output of the higher-complexity machine learning model, generated in response to the task, may not be considered when training the lower-complexity machine learning model. Instead, the system would rely on reference system 340 to judge the accuracy of outputs generated by the shadow agent using the lower-complexity machine learning model. In addition, a critic agent would provide critiques associated with the output of the shadow agent, and the system would rely on reference system 340 to judge the critiques generated by the critic agent. DPO would then be used to iteratively train the lower-complexity machine learning model.

In an embodiment, the system associates the agent with the lower-complexity machine learning model (Operation 635). In accordance with one or more embodiments, the system determines the accuracy of the lower-complexity machine learning model by evaluating its outputs against predefined reference criteria, model-generated benchmarks, or real-world performance metrics. The system applies quantitative and qualitative validation techniques to assess whether the lower-complexity model maintains fidelity to the decision-making patterns of the higher-complexity model while optimizing for efficiency. Some validation workflows compare the lower-complexity model's outputs against ground truth data, applying standard accuracy metrics such as precision, recall, F1-score, or mean squared error, depending on the task type. Some implementations assess model consistency across multiple inference iterations, ensuring that response variability remains within acceptable thresholds.

In accordance with one or more embodiments, the system applies direct comparison techniques that evaluate the alignment between the lower-complexity model's responses and those generated by the higher-complexity model. The system may use similarity metrics, such as cosine similarity, KL divergence, or cross-entropy loss, to measure how closely the lower-complexity model replicates the decision outputs of the more complex counterpart. Some implementations introduce confidence-based evaluation, where the system assesses whether the lower-complexity model's probability distributions over possible outputs align with those of the higher-complexity model. Some configurations use adversarial testing, where task inputs that produce high-variance responses in the lower-complexity model undergo targeted fine-tuning to improve stability.

In accordance with one or more embodiments, the system applies validation through reference system 340 to determine the correctness and contextual appropriateness of the lower-complexity model's responses. Validation module 342 evaluates responses that have explicit ground truth comparisons, such as numerical calculations, structured data retrieval, or factual content. Validation LLM 344 assesses outputs that lack deterministic correctness, such as language generation, summarization, or open-ended responses, applying ranking mechanisms to determine fluency, coherence, or task-specific quality. Some validation workflows integrate human-in-the-loop assessments, where expert reviewers provide additional preference rankings that refine accuracy scoring.

In accordance with one or more embodiments, the system performs task-specific evaluation based on the intended deployment environment of the lower-complexity model. The system may test accuracy within operational constraints such as reduced inference time, lower memory consumption, or adaptation to hardware limitations. Some implementations apply dynamic benchmarking, where the system continuously compares the lower-complexity model's performance against real-world task completions, adjusting accuracy thresholds based on evolving data patterns. Some configurations incorporate feedback loops that identify recurring errors or inconsistencies, adjusting model parameters or retraining schedules accordingly.

Once the model reaches a configurable accuracy threshold metric, the lower-complexity machine learning model may be used for the agent instead of the higher-complexity machine learning model, thereby saving computing resources and other resources such as electricity and maintenance.

In accordance with one or more embodiments, the system identifies opportunities for creating reusable atomic workflows and tools to enhance organizational efficiency, and for enabling modular code generation to improve performance, understanding, and provide greater opportunities for explainability and auditing. To achieve these goals, the system decomposes the agent framework or workflow based on its structure. If the workflow forms a directed acyclic graph (DAG), it suggests that the available tooling is sufficient. However, cycles in the graph may indicate gaps, requiring the creation of new agents, which the system can create. In such cases, the system identifies logical strong components that may correspond to these missing elements.

Once these components are identified, the system prompts the user to determine component reusability. If the user confirms that the component is reusable and has the necessary permissions to authorize code generation, the system generates the corresponding code. The user can then interact with and test the newly generated tools/agents, providing direct feedback in natural language to the coding agent. Once finalized, the code may be committed to the repository or prepared for code review. Upon merging, the tools are versioned and persisted, making them easily discoverable and reusable. This process helps track lineage and manage dependencies across agents and multi-agent workflows.

After integrating these new components, the system revises the workflow graph, ensuring it now forms a DAG. At this stage, the evolved framework code is generated, allowing further user interaction and iterative refinement. Once the process is complete, the workflow is ready for merging and deployment.

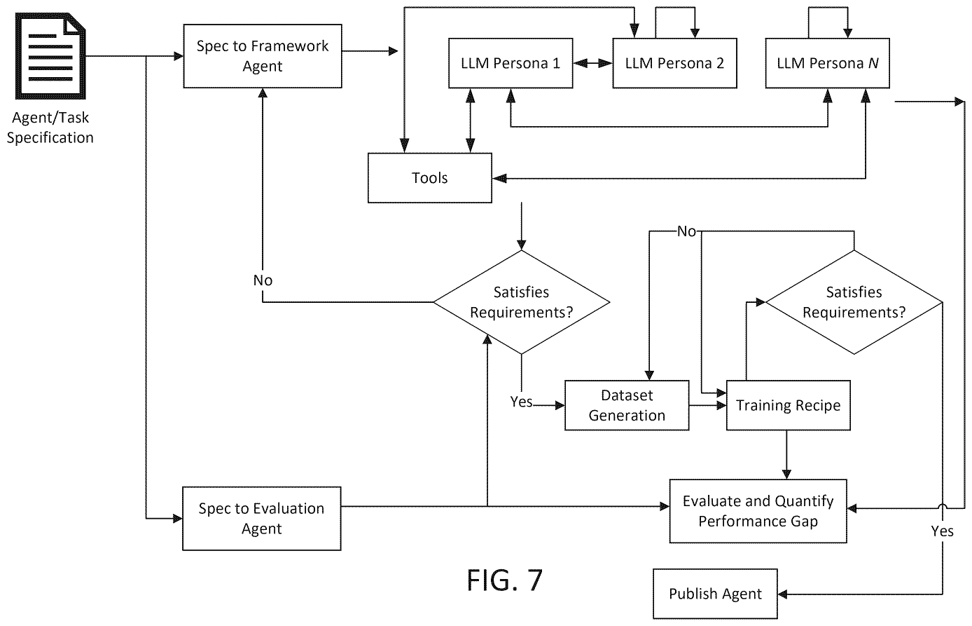

FIG. 7 illustrates an example agent fine-tuning process in accordance with one or more embodiments. In accordance with one or more embodiments, a system is provided for the automated generation, training, and evaluation of task-specific software agents based on a structured task specification. A description of an embodiment follows. The system integrates large language model (LLM) personas, configurable toolchains, and evaluation feedback mechanisms to produce agents that satisfy predefined performance requirements. The process begins with receipt of a task specification that includes a textual or structured description of the desired task, an identification of any existing or preferred agent framework, a step-by-step description of the framework logic and corresponding tool usage, and evaluation criteria defining acceptable outcomes at each stage of agent execution.

The task specification is transmitted to both a framework agent and an evaluation agent. The framework agent interprets the specification and orchestrates agent generation using one or more LLM personas. Each LLM persona may represent a distinct model configuration, prompt strategy, or fine-tuning variant, and is selected based on task characteristics and prior performance data. The framework agent also invokes tools associated with specific framework steps, which may include code generators, data processors, workflow executors, or integration utilities. The resulting agent is constructed by combining outputs from LLM personas and tools into a coherent implementation aligned with the task description.

The agent is then subjected to an initial evaluation stage. The evaluation agent extracts the relevant metrics and criteria from the task specification and executes the agent to assess its performance. If the agent satisfies the specified requirements, it proceeds to a performance quantification phase. If the agent does not meet the criteria, feedback is routed back to the framework agent. The framework agent may generate a revised agent using an alternative set of personas or tools, or with modified intermediate steps, thereby initiating a new generation cycle. This loop continues until an agent meets the base requirements for progression.

In cases where agent performance is inadequate even after framework-level regeneration, the system initiates a dataset and training pipeline. A dataset generation module constructs new training data targeted to known deficiencies in the agent's behavior. A training recipe is selected based on the task domain, identified performance gaps, and agent architecture. The agent is then retrained using the generated dataset and training procedure. After retraining, the updated agent is re-evaluated to determine whether the modifications resolve the performance issues. If the retrained agent remains deficient, the cycle of dataset refinement and retraining may repeat.

Once an agent satisfies the initial evaluation criteria, a final performance evaluation is conducted. This stage includes running the agent in a controlled testing environment and quantifying its outputs against the original task metrics. If the agent's performance is within acceptable tolerances, the system designates the agent as publishable. The agent is then stored, deployed, or otherwise made available for downstream use. The full lifecycle—from specification to publication—is governed by iterative refinement logic, model-persona diversity, and training-based performance correction, enabling scalable, specification-driven agent development.

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis.

### Microservice Applications

According to one or more embodiments, the techniques described herein may be implemented in a microservice architecture. A microservice in this context refers to software logic designed to be independently deployable, having endpoints that may be logically coupled to other microservices to build a variety of applications. Applications built using microservices are distinct from monolithic applications, which are designed as a single fixed unit and generally comprise a single logical executable. With microservice applications, different microservices are independently deployable as separate executables. Microservices may communicate using HyperText Transfer Protocol (HTTP) messages and/or according to other communication protocols via API endpoints. Microservices may be managed and updated separately, written in different languages, and be executed independently from other microservices.

Microservices provide flexibility in managing and building applications. Different applications may be built by connecting different sets of microservices without changing the source code of the microservices. Thus, the microservices act as logical building blocks that may be arranged in a variety of ways to build different applications. Microservices may provide monitoring services that notify a microservices manager (such as If-This-Then-That (IFTTT), Zapier, or Oracle Self-Service Automation (OSSA)) when trigger events from a set of trigger events exposed to the microservices manager occur. Microservices exposed for an application may additionally, or alternatively, provide action services that perform an action in the application (controllable and configurable via the microservices manager by passing in values, connecting the actions to other triggers and/or data passed along from other actions in the microservices manager) based on data received from the microservices manager. The microservice triggers and/or actions may be chained together to form recipes of actions that occur in optionally different applications that are otherwise unaware of or have no control or dependency on each other. These managed applications may be authenticated or plugged in to the microservices manager, for example, with user-supplied application credentials to the manager, without requiring reauthentication each time the managed application is used alone or in combination with other applications.

In one or more embodiments, microservices may be connected via a GUI. For example, microservices may be displayed as logical blocks within a window, frame, other element of a GUI. A user may drag and drop microservices into an area of the GUI used to build an application. The user may connect the output of one microservice into the input of another microservice using directed arrows or any other GUI element. The application builder may run verification tests to confirm that the output and inputs are compatible (e.g., by checking the datatypes, size restrictions, etc.)

### Triggers

The techniques described above may be encapsulated into a microservice, according to one or more embodiments. In other words, a microservice may trigger a notification (into the microservices manager for optional use by other plugged in applications, herein referred to as the “target” microservice) based on the above techniques and/or may be represented as a GUI block and connected to one or more other microservices. The trigger condition may include absolute or relative thresholds for values, and/or absolute or relative thresholds for the amount or duration of data to analyze, such that the trigger to the microservices manager occurs whenever a plugged-in microservice application detects that a threshold is crossed. For example, a user may request a trigger into the microservices manager when the microservice application detects a value has crossed a triggering threshold.

In one embodiment, the trigger, when satisfied, might output data for consumption by the target microservice. In another embodiment, the trigger, when satisfied, outputs a binary value indicating the trigger has been satisfied, or outputs the name of the field or other context information for which the trigger condition was satisfied. Additionally or alternatively, the target microservice may be connected to one or more other microservices such that an alert is input to the other microservices. Other microservices may perform responsive actions based on the above techniques, including, but not limited to, deploying additional resources, adjusting system configurations, and/or generating GUIs.

### Actions

In one or more embodiments, a plugged-in microservice application may expose actions to the microservices manager. The exposed actions may receive, as input, data or an identification of a data object or location of data, that causes data to be moved into a data cloud.

In one or more embodiments, the exposed actions may receive, as input, a request to increase or decrease existing alert thresholds. The input might identify existing in-application alert thresholds and whether to increase or decrease, or delete the threshold. Additionally, or alternatively, the input might request the microservice application to create new in-application alert thresholds. The in-application alerts may trigger alerts to the user while logged into the application, or may trigger alerts to the user using default or user-selected alert mechanisms available within the microservice application itself, rather than through other applications plugged into the microservices manager.

In one or more embodiments, the microservice application may generate and provide an output based on input that identifies, locates, or provides historical data, and defines the extent or scope of the requested output. The action, when triggered, causes the microservice application to provide, store, or display the output, for example, as a data model or as aggregate data that describes a data model.

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

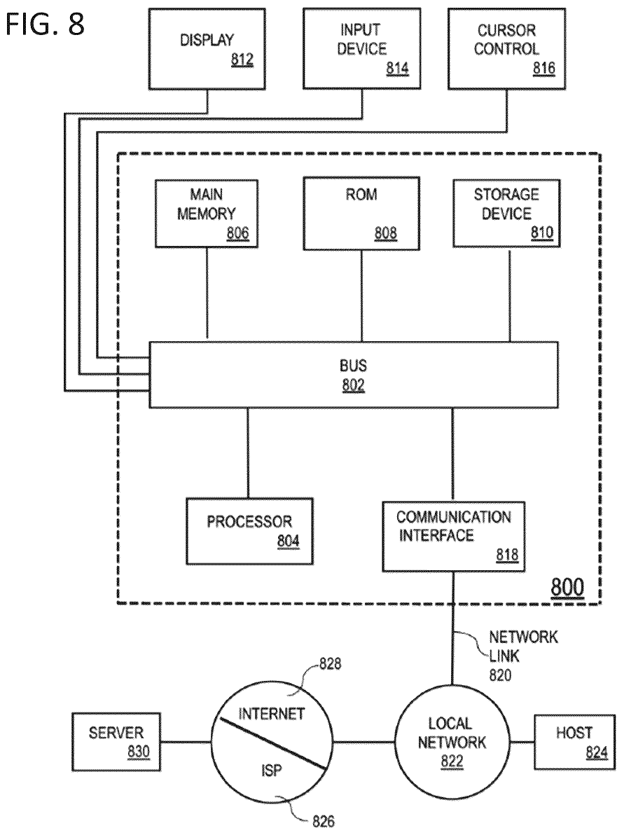

For example, FIG. 8 is a block diagram that illustrates a computer system 800 upon which an embodiment of the disclosure may be implemented. Computer system 800 includes a bus 802 or other communication mechanism for communicating information, and a hardware processor 804 coupled with bus 802 for processing information. Hardware processor 804 may be, for example, a general purpose microprocessor.

Computer system 800 also includes a main memory 806, such as a random access memory (RAM) or other dynamic storage device, coupled to bus 802 for storing information and instructions to be executed by processor 804. Main memory 806 also may be used for storing temporary variables or other intermediate information during execution of instructions to be executed by processor 804. Such instructions, when stored in non-transitory storage media accessible to processor 804, render computer system 800 into a special-purpose machine that is customized to perform the operations specified in the instructions.

Computer system 800 further includes a read only memory (ROM) 808 or other static storage device coupled to bus 802 for storing static information and instructions for processor 804. A storage device 810, such as a magnetic disk, optical disk, or a Solid State Drive (SSD) is provided and coupled to bus 802 for storing information and instructions.

Computer system 800 may be coupled via bus 802 to a display 812, such as a cathode ray tube (CRT), for displaying information to a computer user. An input device 814, including alphanumeric and other keys, is coupled to bus 802 for communicating information and command selections to processor 804. Another type of user input device is cursor control 816, such as a mouse, a trackball, or cursor direction keys for communicating direction information and command selections to processor 804 and for controlling cursor movement on display 812. This input device typically has two degrees of freedom in two axes, a first axis (e.g., x) and a second axis (e.g., y), that allows the device to specify positions in a plane.

Computer system 800 may implement the techniques described herein using customized hard-wired logic, one or more ASICs or FPGAs, firmware and/or program logic which in combination with the computer system causes or programs computer system 800 to be a special-purpose machine. According to one embodiment, the techniques herein are performed by computer system 800 in response to processor 804 executing one or more sequences of one or more instructions contained in main memory 806. Such instructions may be read into main memory 806 from another storage medium, such as storage device 810. Execution of the sequences of instructions contained in main memory 806 causes processor 804 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 810. Volatile media includes dynamic memory, such as main memory 806. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 802. Transmission media can also take the form of acoustic or light waves, such as those generated during radio-wave and infra-red data communications.

Various forms of media may be involved in carrying one or more sequences of one or more instructions to processor 804 for execution. For example, the instructions may initially be carried on a magnetic disk or solid state drive of a remote computer. The remote computer can load the instructions into its dynamic memory and send the instructions over a telephone line using a modem. A modem local to computer system 800 can receive the data on the telephone line and use an infra-red transmitter to convert the data to an infra-red signal. An infra-red detector can receive the data carried in the infra-red signal and appropriate circuitry can place the data on bus 802. Bus 802 carries the data to main memory 806, from which processor 804 retrieves and executes the instructions. The instructions received by main memory 806 may optionally be stored on storage device 810 either before or after execution by processor 804.

Computer system 800 also includes a communication interface 818 coupled to bus 802. Communication interface 818 provides a two-way data communication coupling to a network link 820 that is connected to a local network 822. For example, communication interface 818 may be an integrated services digital network (ISDN) card, cable modem, satellite modem, or a modem to provide a data communication connection to a corresponding type of telephone line. As another example, communication interface 818 may be a local area network (LAN) card to provide a data communication connection to a compatible LAN. Wireless links may also be implemented. In any such implementation, communication interface 818 sends and receives electrical, electromagnetic or optical signals that carry digital data streams representing various types of information.

Network link 820 typically provides data communication through one or more networks to other data devices. For example, network link 820 may provide a connection through local network 822 to a host computer 824 or to data equipment operated by an Internet Service Provider (ISP) 826. ISP 826 in turn provides data communication services through the world wide packet data communication network now commonly referred to as the “Internet” 828. Local network 822 and Internet 828 both use electrical, electromagnetic or optical signals that carry digital data streams. The signals through the various networks and the signals on network link 820 and through communication interface 818, which carry the digital data to and from computer system 800, are example forms of transmission media.

Computer system 800 can send messages and receive data, including program code, through the network(s), network link 820 and communication interface 818. In the Internet example, a server 830 might transmit a requested code for an application program through Internet 828, ISP 826, local network 822 and communication interface 818.

The received code may be executed by processor 804 as it is received, and/or stored in storage device 810, or other non-volatile storage for later execution.

Unless otherwise defined, all terms (including technical and scientific terms) are to be given their ordinary and customary meaning to a person of ordinary skill in the art, and are not to be limited to a special or customized meaning unless expressly so defined herein.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. A method comprising:
in response to receiving instructions, a generating agent using a corresponding machine learning model to generate a set of results;
using a reference system, generating a corresponding accuracy indicator for each result in the set of results;
a critiquing agent using a corresponding machine learning model to generate a corresponding critique that is based, at least in part, on the corresponding accuracy indicator for that result;
training the machine learning model corresponding to the generating agent using a training data set, wherein the training data set includes:
a) the instructions,
b) a particular result of the set of results, and
c) a critique corresponding to the particular result;
wherein the method is performed by at least one device including a hardware processor.

2. The method of claim 1, wherein training the machine learning model corresponding to the generating agent comprises using direct preference optimization.

3. The method of claim 1, wherein the set of results is a subset of a larger set of results generated by the generating agent in response to receiving the instructions, and wherein each result in the set of results is selected for membership in the set of results based at least in part on a determination that each result of the set of results meet a quality threshold, wherein the quality threshold indicates a usefulness of a result-critique combination for model training purposes.

4. The method of claim 1, further comprising:
determining a corresponding critique accuracy indicator for one or more critiques; and
for each of the one or more critiques, generating a corresponding critique based at least in part on the corresponding critique accuracy indicator.

5. The method of claim 4, wherein training the machine learning model corresponding to the generating agent includes using a plurality of training sets that each include a critique, and a reward is assigned to each training set at least in part on an accuracy determination of the corresponding critique.

6. A method comprising:
receiving a framework generation request that includes agent role information;
based at least in part on the framework generation request, generating an agentic framework configuration with a set of one or more agents to be created;
based at least in part on the agent role information, generating an agent of the set of agents, wherein the agent is associated with a role and an initial machine learning model;
receiving, at the agent, a task request;
the agent receiving a task request and performing the requested task in a manner consistent with the role associated with the agent using the initial machine learning model, to generate a task result;
using at least the task request and the task result to train a lower-complexity machine learning model;
associating the agent with the lower-complexity machine learning model instead of the initial machine learning model; and
wherein the method is performed by at least one device including a hardware processor.

7. The method of claim 6, further comprising:
associating agent with the lower-complexity machine learning model instead of the initial machine learning model is performed in response to determining that the lower-complexity machine learning model has achieved a triggering accuracy threshold.

8. The method of claim 6, further comprising:
based at least in part on the agent role information, generating an additional agent that is associated with a corresponding role and an initial critique-focused machine learning model;
receiving, at the additional agent, output from the agent;
generating, by the additional agent, a critique of the task result, wherein the critique is associated with a reward; and
using at least the reward to train the initial critique-focused machine learning model.

9. The method of claim 8, further comprising:
wherein the additional agent is associated with the role of a critic;
wherein generating a critique of the task result is based at least in part on association between the additional agent and the role of a critic;
wherein the additional agent generates the critique of the task result using the machine learning model corresponding to the additional agent;
using at least the critique of the task request a critique accuracy indicator to train a lower-complexity critique-focused machine learning model; and
associating the additional agent with the lower-complexity critique-focused machine learning model instead of the initial critique-focused machine learning model.

10. The method of claim 9, further comprising:
wherein the step of associating the additional agent with the lower-complexity critique-focused machine learning model instead of the initial critique-focused machine learning model is performed in response to determining that the lower-complexity critique-focused machine learning model has achieved a triggering accuracy threshold.

11. A system comprising:
memory to store software; and
a hardware processor coupled to the memory, the hardware processor configured to execute the software to:
in response to receiving instructions, a generate agent using a corresponding machine learning model to generate a set of results;
using a reference system, generate a corresponding accuracy indicator for each result in the set of results;
a critiquing agent using a corresponding machine learning model to generate a corresponding critique that is based, at least in part, on the corresponding accuracy indicator for that result;
train the machine learning model corresponding to the generating agent using a training data set, wherein the training data set includes:
a) the instructions,
b) a particular result of the set of results, and
c) a critique corresponding to the particular result.

12. The system of claim 11, wherein training the machine learning model corresponding to the generating agent is to use direct preference optimization.

13. The system of claim 11, wherein the set of results is a subset of a larger set of results generated by the generating agent in response to receiving the instructions, and wherein each result in the set of results is selected for membership in the set of results based at least in part on a determination that each result of the set of results meet a quality threshold, wherein the quality threshold indicates a usefulness of a result-critique combination for model training purposes.

14. The system of claim 11, wherein the hardware processor is further configured to:
determine a corresponding critique accuracy indicator for one or more critiques; and
for each of the one or more critiques, generate a corresponding critique based at least in part on the corresponding critique accuracy indicator.

15. The system of claim 14, wherein training the machine learning model corresponding to the generating agent includes using a plurality of training sets that each include a critique, and a reward is assigned to each training set at least in part on an accuracy determination of the corresponding critique.
